(19) United States
(12) Patent Application Publication
(10) Pub. No.: US 2025/0327655 A1
(43) Pub. Date: Oct. 23, 2025

(54) OPTICAL DISPLACEMENT MEASUREMENT SYSTEM

(71) Applicant: Keyence Corporation, Osaka (JP)

(72) Inventor: Yoshitaka TSUCHIDA, Osaka (JP)

(73) Assignee: Keyence Corporation, Osaka (JP)

(21) Appl. No.: 19/095,069

(22) Filed: Mar. 31, 2025

(30) Foreign Application Priority Data
Apr. 18, 2024 (JP) 2024-067163

(51) Int. Cl. G01B 11/00; G01B 11/24; G06T 7/55

(52) U.S. Cl. CPC G01B 11/005; G01B 11/24; G06T 7/55; G06T 2207/10144; G06T 2207/30164

(57) ABSTRACT

An optical displacement measurement system controls a light projecting/receiving module so as to sequentially acquire a plurality of light reception images of a workpiece based on each of a plurality of exposure times while causing a moving mechanism to relatively move the light projecting/receiving module and the workpiece within each of measurement ranges including at least a common range, acquires XYZ coordinate information indicating a shape of the workpiece for each of the plurality of exposure times to generate a workpiece image, and generates a setting screen for displaying a plurality of the workpiece images respectively corresponding to the plurality of exposure times. The setting device is configured to be capable of receiving selection of one exposure time from the plurality of exposure times via the setting screen, and then receiving adjustment of an image processing parameter to be executed for the plurality of light reception images.

### CROSS-REFERENCE TO RELATED APPLICATIONS

The present application claims foreign priority based on Japanese Patent Application No. 2024-067163, filed Apr. 18, 2024, the contents of which are incorporated herein by reference.

### BACKGROUND OF THE INVENTION

### 1. Technical Field

The present invention relates to an optical displacement measurement system that detects a displacement of a measurement object by a triangulation method.

### 2. Description of the Related Art

In an optical displacement measurement system using a light sectioning method, a measurement object (hereinafter, referred to as a workpiece) is irradiated with band-shaped light having a linear cross-section from a light projecting unit, and reflected light thereof is received by a two-dimensional light receiving element (image sensor). A profile (two-dimensional cross-sectional profile) of the workpiece is measured based on a position of a peak of a light receiving amount distribution obtained by the light receiving element, and a workpiece image indicating a shape of the workpiece is generated from the two-dimensional cross-sectional profile.

In a conventional optical displacement measurement system, a user adjusts brightness (an exposure time of an image sensor) while confirming light receiving amount information in units of two-dimensional cross-sectional profiles.

By the way, there is known a technique in which an image is displayed based on three-dimensional shape data measured under each of a plurality of measurement conditions including an exposure time is displayed so that a user can select an optimum measurement condition while confirming the image (for example, see JP 2014-055815 A).

In the conventional optical displacement measurement system, more appropriate adjustment can be expected if the user can adjust the brightness while confirming the entire measurement range through a workpiece image instead of the light receiving amount information in units of two-dimensional cross-sectional profiles.

However, a relative movement between a light projecting/receiving module and a workpiece is required in order to enable the user to adjust the brightness while confirming the entire measurement range through the workpiece image in the conventional optical displacement measurement system.

For this reason, in the optical displacement measurement system, it is necessary to capture an image after the same relative movement or a relative movement in the opposite direction is reproduced under each of a plurality of exposure conditions in order to change an exposure condition for a retake. That is, the user is forced to determine which exposure condition to finally select by repeatedly performing work of “changing an exposure condition and then causing the same relative movement” for each of the exposure conditions and separately comparing workpiece images taken under the respective exposure conditions. Therefore, it takes time and effort until the user selects an appropriate exposure time in the conventional optical displacement measurement system.

In JP 2014-055815 A, the user can select the optimum measurement condition from the plurality of measurement conditions including the exposure time, but there is no room for fine adjustment. For example, there may be a case where it is desired to first select an appropriate exposure time and then adjust an image processing parameter for a light reception image obtained with the exposure time so as to enable more accurate measurement, but such a fact is not considered in JP 2014-055815 A. In addition, optimization of a control parameter of a moving mechanism is not considered in JP 2014-055815 A.

### SUMMARY OF THE INVENTION

An object of the present invention is to provide an optical displacement measurement system capable of improving the efficiency of setting for a user to select an appropriate measurement condition.

According to one embodiment of the present invention, an optical displacement measurement system includes: a light projecting/receiving module including a light projecting unit that irradiates a workpiece with slit light extending in an X direction and an image sensor that includes a plurality of pixels two-dimensionally arranged in a U direction corresponding to the X direction and a V direction orthogonal to the U direction, receives reflected light reflected from the workpiece by the plurality of pixels, and outputs a light reception image indicating a light receiving amount distribution; a moving mechanism that relatively moves the light projecting/receiving module and the workpiece; a setting device configured to set control conditions of the light projecting/receiving module and the moving mechanism; and a control unit that controls the light projecting/receiving module and the moving mechanism based on the control conditions. The control condition includes a plurality of exposure times, different from each other, of the image sensor. The control unit controls the light projecting/receiving module to sequentially acquire a plurality of the light reception images of the workpiece based on each of the plurality of exposure times while causing the moving mechanism to relatively move the light projecting/receiving module and the workpiece within each of measurement ranges including at least a common range, acquires XYZ coordinate information indicating a shape of the workpiece based on the plurality of light reception images for each of the plurality of exposure times to generate a workpiece image indicating the shape of the workpiece based on the XYZ coordinate information, and generates a setting screen for displaying a plurality of the workpiece images respectively corresponding to the plurality of exposure times. The setting device is configured to be capable of receiving selection of one exposure time from the plurality of exposure times via the setting screen, and then receiving adjustment of an image processing parameter to be executed for the plurality of light reception images acquired based on the selected exposure time.

According to another embodiment of the present invention, an optical displacement measurement system includes: a light projecting/receiving module including a light projecting unit that irradiates a workpiece with slit light extending in an X direction and an image sensor that includes a plurality of pixels two-dimensionally arranged in a U direction corresponding to the X direction and a V direction orthogonal to the U direction, receives reflected light reflected from the workpiece by the plurality of pixels, and outputs a light reception image indicating a light receiving amount distribution; a moving mechanism that relatively moves the light projecting/receiving module and the workpiece; a setting device configured to set control conditions of the light projecting/receiving module and the moving mechanism; and a control unit that controls the light projecting/receiving module and the moving mechanism based on the control conditions. The control conditions include a plurality of exposure times, different from each other, of the image sensor. The control unit controls the light projecting/receiving module to sequentially acquire a plurality of the light reception images of the workpiece based on each of the plurality of exposure times while causing the moving mechanism to relatively move the light projecting/receiving module and the workpiece within each of measurement ranges including at least a common range, acquires XYZ coordinate information indicating a shape of the workpiece based on the plurality of light reception images for each of the plurality of exposure times to generate a workpiece image indicating the shape of the workpiece based on the XYZ coordinate information, and generates a setting screen for displaying a plurality of the workpiece images respectively corresponding to the plurality of exposure times. The control conditions include the measurement range, a drive control parameter including a movement speed of the moving mechanism, and a number of times of imaging of the image sensor within the measurement range. The setting device determines the drive control parameter based on the measurement range, the number of times of imaging of the image sensor within the measurement range, and each of the plurality of exposure times.

Note that other features, elements, steps, advantages, and characteristics will be more apparent from the following detailed description of preferred embodiments and the accompanying drawings.

According to the optical displacement measurement system of the present invention, it is possible to improve the efficiency of the setting for the user to select the appropriate measurement condition.

### BRIEF DESCRIPTION OF THE DRAWINGS

FIG. 1 is a diagram illustrating an optical displacement measurement system according to a first embodiment;

FIG. 2 is a diagram illustrating a measurement range of a rotary optical displacement meter;

FIG. 3 is a view illustrating the optical displacement meter including a reflecting member;

FIG. 4 is a view for describing a method of detecting a peak position;

FIG. 5 is a functional block diagram of the optical displacement meter;

FIG. 6 is a view illustrating a processing flow for setting an exposure time of the optical displacement measurement system;

FIG. 7 is a view illustrating a processing flow for setting parameters of a peak width filter of the optical displacement measurement system;

FIG. 8 is a view illustrating a processing flow for setting parameters of peak selection of the optical displacement measurement system;

FIG. 9A is a view illustrating a graphical user interface (GUI);

FIG. 9B is a view illustrating a GUI;

FIG. 9C is a view illustrating a GUI;

FIG. 9D is a view illustrating a GUI;

FIG. 9E is a view illustrating a GUI;

FIG. 9F is a view illustrating a GUI;

FIG. 9G is a view illustrating a GUI;

FIG. 9H is a view illustrating a GUI;

FIG. 10 is a flowchart illustrating a procedure for determining control parameters of a motor;

FIG. 11 is a view illustrating an optical displacement measurement system according to a second embodiment;

FIG. 12 is a view illustrating the principle of triangulation;

FIG. 13 is a view for describing a method of detecting a peak position;

FIG. 14 is a functional block diagram of an optical displacement meter; and

FIG. 15 is a diagram illustrating a modified example of the optical displacement meter.

### DETAILED DESCRIPTION

Hereinafter, embodiments of the present invention will be described in detail with reference to the drawings. Note that the following preferred embodiments are described merely as examples in essence, and there is no intention to limit the invention, its application, or its use.

### First Embodiment

### <Optical Displacement Measurement System>

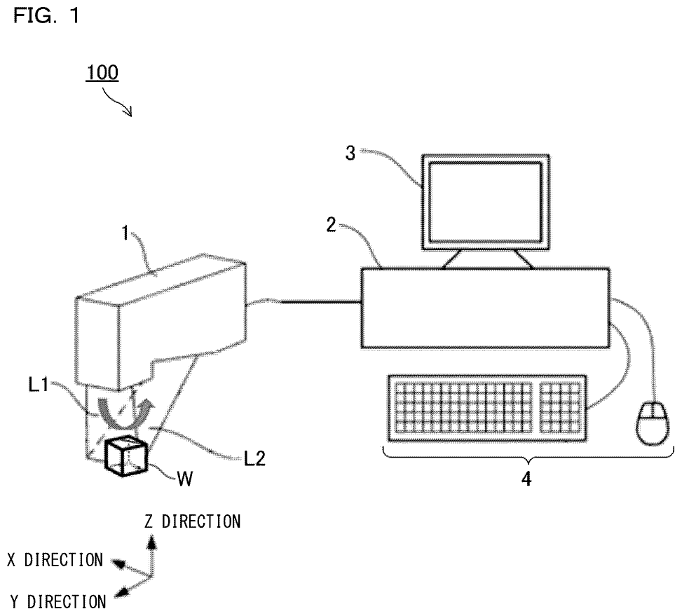

FIG. 1 is a diagram illustrating a schematic configuration example of an optical displacement measurement system according to a first embodiment. An optical displacement measurement system 100 illustrated in FIG. 1 includes an optical displacement meter 1, a control device 2, a display device 3, and an input device 4.

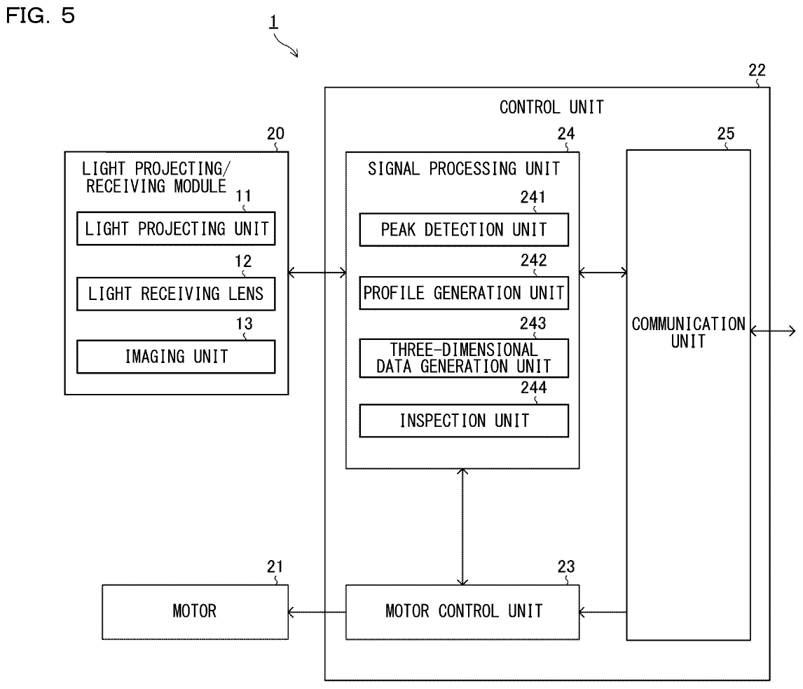

In the present embodiment, an X direction corresponds to a width direction of slit light L1 output from the optical displacement meter 1, a Z direction corresponds to a height direction of a workpiece W, and a Y direction corresponds to a direction in which the slit light L1 moves by rotation of a light projecting unit (not illustrated in FIG. 1). A XZ plane to be described later is a plane extending in the X direction and the Z direction. Note that the optical displacement meter 1 scans the slit light L1 by rotating a light projecting/receiving module 20 (see FIG. 5 to be described later), and thus, a scanning direction of the slit light L1 is a direction orthogonal to the X direction on a YZ plane including the Y direction. Note that “rotation” in the present specification means swinging motion that reciprocates with a rotation axis as the center.

The optical displacement measurement system 100 is a system that measures a profile and a three-dimensional shape of the workpiece W. The profile of the workpiece W is data indicating an outer edge of a cut surface of the workpiece W by the slit light L1. When the slit light is emitted in parallel to the XZ plane, the profile of the workpiece W is data indicating an outer edge of a cut surface parallel to the XZ plane, and thus, is also referred to as a two-dimensional profile of a XZ cross-section of the workpiece W.

For example, the profile is an aggregate of (xi, zi) (i is an index). “xi” indicates a position in the X direction. “zi” indicates a height in the Z direction. Note that the three-dimensional shape is an aggregate of (xi, yi, zi). “yi” indicates a position in the Y direction.

The optical displacement meter 1 operates in accordance with an instruction from the control device 2. The optical displacement meter 1 outputs the slit light L1 extending in the X direction and receives reflected light L2 from the workpiece W. Then, the optical displacement meter 1 calculates a profile of the workpiece W based on a light reception result. The optical displacement meter 1 captures images at regular intervals to generate profiles of the workpiece W having different values of yi. In addition, the optical displacement meter 1 generates three-dimensional shape data of the workpiece W from the profiles of the workpiece W having different values of yi.

The control device 2 outputs an instruction based on a user input received by the input device 4 to the optical displacement meter 1, and receives a measurement result of the workpiece W from the optical displacement meter 1. In addition, the control device 2 outputs a display signal to the display device 3. The control device 2 is, for example, a personal computer, a programmable logic control unit, or the like. The control device 2 is also a setting device configured to set control conditions of the light projecting/receiving module 20 and a moving mechanism (a moving mechanism for relatively moving the light projecting/receiving module 20 and the workpiece W) including a motor 21 (see FIG. 5 to be described later). In a case where the input device 4 is operated by a user, the control device 2 detects the operation, and receives the setting of the control conditions of the light projecting/receiving module 20 and the moving mechanism including the motor 21. The control device 2 includes a storage unit, and the storage unit stores a program (hereinafter referred to as an “imaging navigation program”) for setting the control conditions of the light projecting/receiving module 20 and the moving mechanism including and the motor 21, default settings of the control conditions of the light projecting/receiving module 20 and the motor 21, XYZ coordinate information indicating a shape of the workpiece W, and the like.

The display device 3 displays, for example, the measurement result of the workpiece W, a user interface (UI) for setting the optical displacement meter 1, and the like based on the display signal from the control device 2.

The input device 4 receives the user input with respect to the optical displacement measurement system 100. In FIG. 1, a keyboard and a mouse are illustrated as the input device 4. However, the input device 4 is not limited to the keyboard and the mouse. For example, the input device 4 may be a touch panel disposed on a display screen of the display device 3.

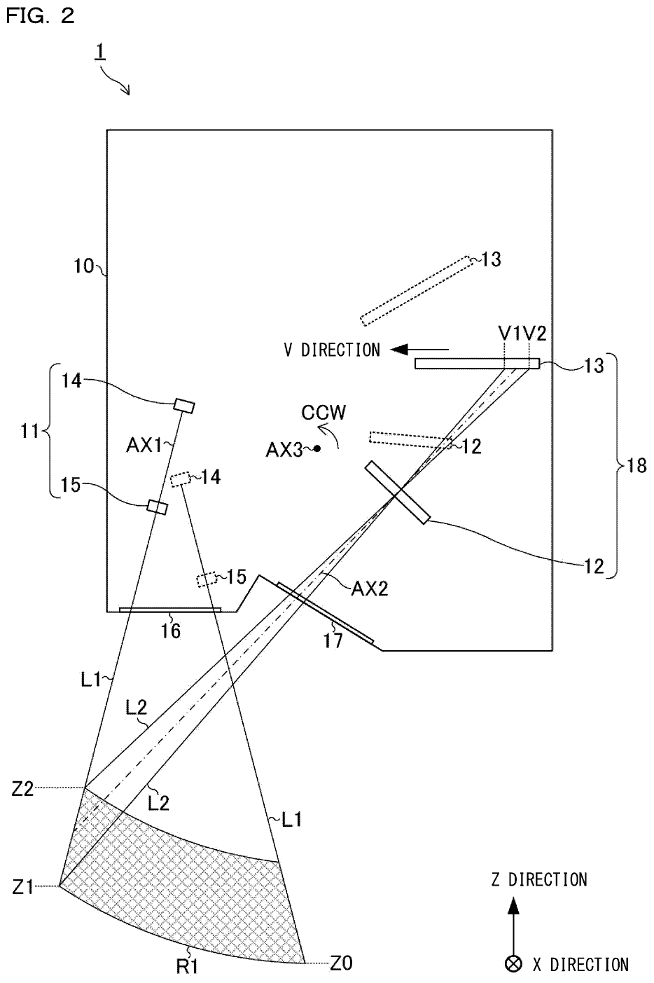

FIG. 2 is a diagram illustrating a measurement range of the rotary optical displacement meter 1. A light projecting unit 11, a light receiving lens 12, and an imaging unit 13 are stored in a housing 10 of the optical displacement meter 1. The light projecting unit 11 includes a light source 14 and a light projecting lens 15. For example, the light source 14 may be a laser light emitter, and the light projecting lens 15 may include a plurality of lenses including a cylindrical lens.

Light output from the light source 14 passes through the light projecting lens 15 and is converted into the slit light L1. The housing 10 is provided with a light projecting window 16 having a light transmitting property that allows the slit light L1 to pass therethrough. Similarly, the housing 10 is provided with a light receiving window 17 having a light transmitting property that allows the reflected light L2 to pass therethrough. The light projecting window 16 and the light receiving window 17 are separate bodies (separate components). Since the light projecting window 16 and the light receiving window 17 are separate bodies, each of the light projecting window 16 and the light receiving window 17 is a flat plate-shaped component, and the light projecting window 16 and the light receiving window 17 can be easily manufactured. However, the light projecting window 16 and the light receiving window 17 may be integrated (one component).

The light receiving lens 12 is a lens configured to collect the reflected light L2 and form an image on a light receiving surface of the imaging unit 13. The light receiving lens 12 may include only one lens or may include a plurality of lenses. In addition, the light receiving lens 12 may also include an optical component (for example, an optical filter or the like) other than the lens. The imaging unit 13 is an image sensor including a plurality of photoelectric conversion elements arranged two-dimensionally. The imaging unit 13 receives the light collected by the light receiving lens.

As illustrated in FIG. 2, an optical axis AX2 of the light receiving lens 12 is inclined with respect to a light projection axis AX1 of the light projecting unit 11. The light projection axis AX1 of the light projecting unit 11 coincides with an optical axis of the light source 14. As a result, the reflected light L2 from a height Z1 forms an image at a position V1 in a V direction of the light receiving surface of the imaging unit 13, and the reflected light L2 from a height Z2 forms an image at a position V2 in the V direction of the light receiving surface of the imaging unit 13. That is, the V direction of the light receiving surface of the imaging unit 13 corresponds to the Z direction of the workpiece W. Although a U direction of the light receiving surface of the imaging unit 13 is not illustrated, the U direction corresponds to the X direction of the workpiece W. That is, a vertical direction of a light reception image indicating a light receiving amount distribution output by the imaging unit 13 is the V direction, and a horizontal direction thereof is the U direction.

The light projecting unit 11, the light receiving lens 12, and the imaging unit 13 are rotatable about a rotation axis AX3 along the X direction. Relative positions of the light projecting unit 11, the light receiving lens 12, and the imaging unit 13 are fixed. In FIG. 2, a state of the light projecting unit 11, the light receiving lens 12, and the imaging unit 13 before rotation in a counterclockwise direction CCW is illustrated by a solid line, and a state thereof after rotation in the counterclockwise direction CCW is illustrated by a broken line.

When a rotation range of the motor 21 (see FIG. 5 to be described later) is limited, rotation ranges of the light projecting unit 11, the light receiving lens 12, and the imaging unit 13 are also limited. The rotation range of the motor 21 may be limited by, for example, the control of the motor 21 or by a stopper that physically stops the motion of the light projecting/receiving module 20 (see FIG. 5 to be described later).

At one end of the rotation range of the motor 21, the light receiving window 17 and an end on the workpiece W side of the light receiving unit 18 including the light receiving lens 12 and the imaging unit 13 are closest to each other while being separated from each other, and an inner wall of the housing 10 and the light projecting unit 11 are separated from each other. At the other end of the rotation range of the motor 21, the light projecting window 16 and the end on the workpiece W side of the light projecting unit 11 are closest to each other while being separated from each other, and the inner wall of the housing 10 and the light receiving unit 18 are separated from each other. As a result, the housing 10 can be reduced in size while avoiding contact between the light receiving window 17 and the light receiving unit 18 and contact between the light projecting window 16 and the light projecting unit 11.

The light projecting unit 11, the light receiving lens 12, and the imaging unit 13 are rotatable about a rotation axis AX3 along the X direction in a state of satisfying the Scheimpflug relationship in which the light receiving surface of the imaging unit 13 is inclined with respect to the optical axis of the light receiving lens 12. As a result, each cross-section through which the light projection axis AX1 passes is in focus in a region R1 illustrated by hatching in FIG. 2. That is, the optical displacement meter 1 can generate the profile of the workpiece W in focus even if the height of the workpiece W changes. Therefore, it is sufficient to use the region R1 as a measurement range of the slit light L1. That is, it is sufficient to form the measurement range of the slit light L1 using a range in which the Scheimpflug relationship is established for each rotation angle of the motor 21 (see FIG. 5 to be described later).

Note that the positional relationship among the light projecting unit 11, the light receiving lens 12, and the imaging unit 13 may be opposite to the positional relationship illustrated in FIG. 2.

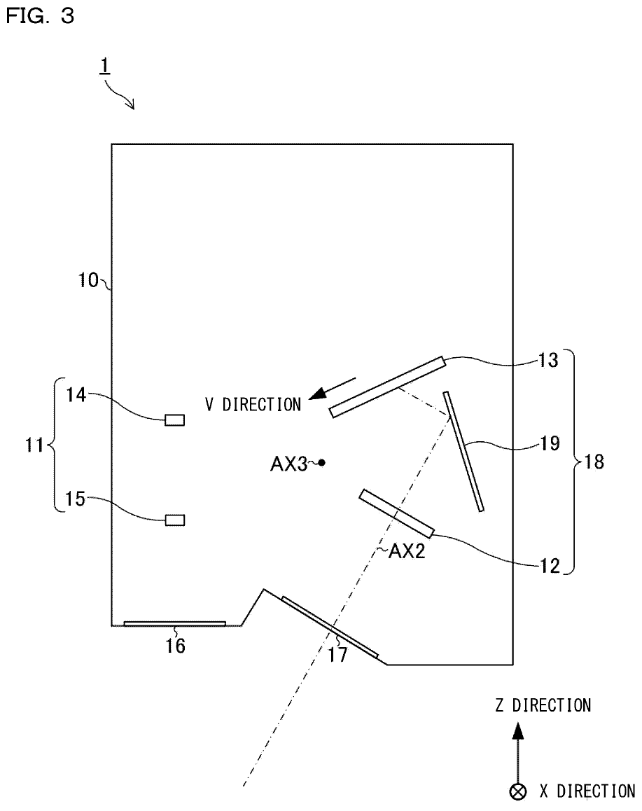

In addition, the optical displacement meter 1 may further include a reflecting member 19 as illustrated in FIG. 3. In a case where the optical displacement meter 1 includes the reflecting member 19, a light receiving unit 18 includes the light receiving lens 12, the imaging unit 13, and the reflecting member 19. The reflecting member 19 is provided on an optical path between the light receiving window 17 and the imaging unit 13, and turns the reflected light L2 and the optical axis AX2 of the light receiving lens 12 toward the light projecting unit 11. As a result, it is possible to form a compact light projecting/receiving module that integrally holds the light projecting unit 11, the light receiving lens 12, the imaging unit 13, and the reflecting member 19 in the YZ plane extending in the Y direction and the Z direction. Therefore, it is possible to reduce a moment of inertia about the rotation axis AX3 of the light projecting/receiving module integrally holding the light projecting unit 11, the light receiving lens 12, the imaging unit 13, and the reflecting member 19.

In FIG. 3, the reflecting member 19 is provided on the optical path between the light receiving lens 12 and the imaging unit 13, but may be provided on an optical path between the light receiving window 17 and the light receiving lens 12.

In a case where the reflecting member 19 is provided on the optical path between the light receiving lens 12 and the imaging unit 13, the reflecting member 19 reflects the light collected by the light receiving lens 12, and thus, the area of a reflection surface of the reflecting member 19 can be reduced. In a case where the reflecting member 19 is provided on the optical path between the light receiving window 17 and the light receiving lens 12, the heavy light receiving lens 12 can be disposed close to the rotation axis AX3, and thus, the effect of reducing the moment of inertia increases.

### <Position (Calculation of Height)>

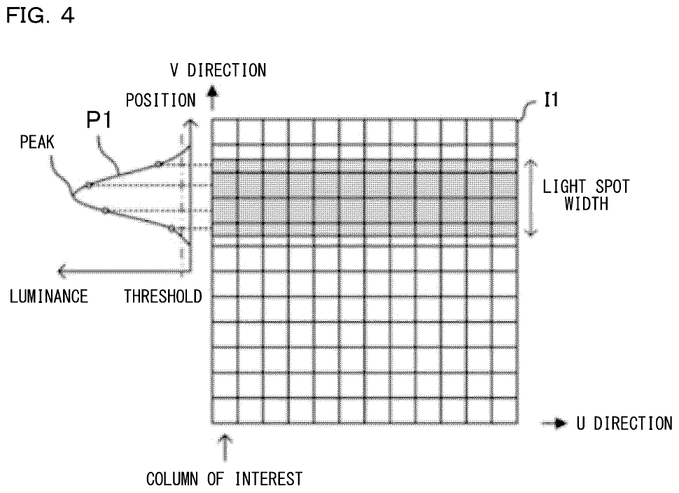

FIG. 4 is a view for describing a method of calculating a height forming a profile from an image I1 that is a light reception result output by the imaging unit 13. The slit light L1 has a certain width in the Y direction. Therefore, a width of a light spot formed by the reflected light L2 on the light receiving surface of the imaging unit 13 is also a width that spans the plurality of photoelectric conversion elements.

Therefore, the optical displacement meter 1 obtains an approximate curve P1 indicating a change in a luminance value from luminance values of pixels, and calculates a position in the V direction at which a peak value is obtained in the approximate curve P1. In FIG. 4, the leftmost column is a column of interest, and the distribution (approximate curve P1) of luminance values of the column of interest is illustrated. The approximate curve P1 is obtained by curve fitting or the like of a plurality of sample values. A sample value below a detection threshold is not considered. The position in the V direction at which the peak value is obtained indicates a height of the workpiece W. The optical displacement meter 1 obtains the approximate curve P1 at each position (each pixel column) in the U direction, and calculates the position (height) in the V direction at which the peak value is obtained from the approximate curve P1. This calculation processing is executed at each position in the U direction, thereby obtaining one profile. Such calculation processing may be referred to as subpixel processing.

Note that, for example, a coordinate conversion condition (for example, a coordinate conversion table) indicating a correspondence relationship among UV coordinates, a rotation angle θ, and local coordinates (X, Y, Z) and expressed by (U, V, θ)=(X, Y, Z) is generated by calibration before shipment, and is stored in a storage unit (not illustrated) of the optical displacement meter 1, and thus, the optical displacement meter 1 can convert a profile in a UV coordinate system into that in an XYZ coordinate system based on the rotation angle θ by simple calculation. Note that, in the coordinate conversion, equal interval correction in the X direction and the Y direction may be executed such that positions in the X direction and the Y direction are plotted at equal intervals, and a Z coordinate corresponding to the corrected (X, Y) may be obtained by linear interpolation or the like and output as a measurement result. Image processing to be performed on the measurement result is often based on data sampled at equal intervals in the X direction and the Y direction, and thus the subsequent image processing is facilitated by the equal interval correction.

### <Functional Blocks>

FIG. 5 is a functional block diagram of the optical displacement meter 1. The optical displacement meter 1 includes the light projecting/receiving module 20, a motor 21, and a control unit 22.

The light projecting/receiving module 20 holds the light projecting unit 11, the light receiving lens 12, and the imaging unit 13 in an integrated manner. In addition, in a case where the optical displacement meter 1 includes the reflecting member 19, the light projecting/receiving module 20 holds the light projecting unit 11, the light receiving lens 12, the imaging unit 13, and the reflecting member 19 (not illustrated in FIG. 5) in an integrated manner.

The motor 21 rotates the light projecting unit 11, the light receiving lens 12, and the imaging unit 13. More specifically, the motor 21 rotates the light projecting/receiving module 20. The motor 21 may rotate the light projecting/receiving module 20 by a direct drive system in which an intermediate mechanism such as a speed reducer is not disposed between the motor 21 and the light projecting/receiving module 20, or may rotate the light projecting/receiving module 20 via the intermediate mechanism such as the speed reducer.

The control unit 22 includes a motor control unit 23, a signal processing unit 24, and a communication unit 25. The control unit 22 controls the motor 21 to rotate the light projecting unit 11, the light receiving lens 12, and the imaging unit 13 in the state of satisfying the Scheimpflug relationship, and scans the slit light L1 in a direction intersecting the X direction. More specifically, the motor control unit 23 controls the motor 21 to rotate the light projecting unit 11, the light receiving lens 12, and the imaging unit 13 in the state of satisfying the Scheimpflug relationship, and the signal processing unit 24 controls the light projecting unit 11 to emit the slit light L1 from the light projecting unit 11.

The signal processing unit 24 includes a peak detection unit 241, a profile generation unit 242, a three-dimensional data generation unit 243, and an inspection unit 244.

The peak detection unit 241 detects positions (peak positions) in the V direction having peaks of luminance values based on light reception results output from the imaging unit 13. The profile generation unit 242 generates one piece of profile data by collecting heights (zi) of the workpieces W at the respective positions (xi) in the X direction obtained by the peak detection unit 241. The three-dimensional data generation unit 243 generates three-dimensional shape data of the workpiece W from profiles of the workpieces W having different values of yi and generated by the profile generation unit 242.

The inspection unit 244 inspects the workpiece W based on the three-dimensional shape data of the workpiece W generated by the three-dimensional data generation unit 243. The inspection unit 244 performs predetermined measurement on the three-dimensional shape data of the workpiece W, and inspects the workpiece W based on a result of the measurement. For example, the inspection unit 244 measures a length, an angle, and the like of a predetermined portion of the workpiece W. Then, the inspection unit 244 determines whether the workpiece W is a non-defective product based on these measurement results, preset thresholds, and the like.

Note that at least some of the peak detection unit 241, the profile generation unit 242, the three-dimensional data generation unit 243, and the inspection unit 244 may be provided at a place separated from a main body of the optical displacement meter 1 (for example, inside the control device 2 illustrated in FIG. 1). In this case, the optical displacement meter 1 has a separate structure including the main body of the optical displacement meter 1 and a separate portion of the optical displacement meter 1.

The communication unit 25 performs wired or wireless communication with the control device 2. For example, the communication unit 25 receives an instruction from the control device 2 and transmits the instruction to the control unit 22. In addition, the communication unit 25 transmits, for example, the profile data and the three-dimensional shape data of the workpiece W generated by the signal processing unit 24 and an inspection result of the workpiece W determined by the inspection unit 244 to the control device 2.

### <Processing Flow>

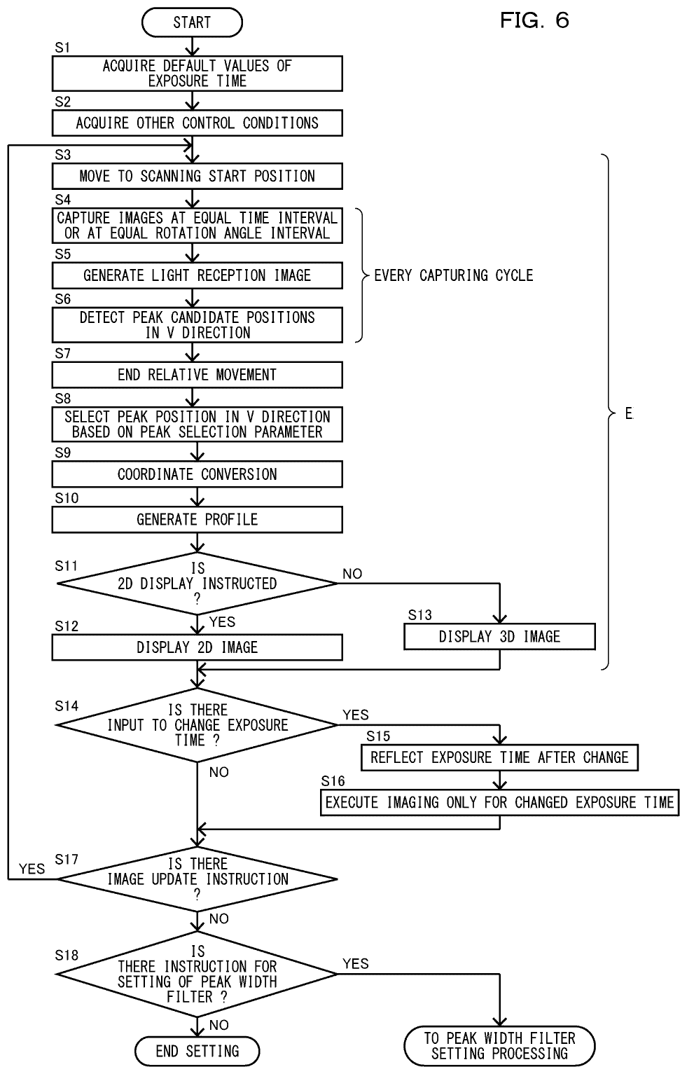

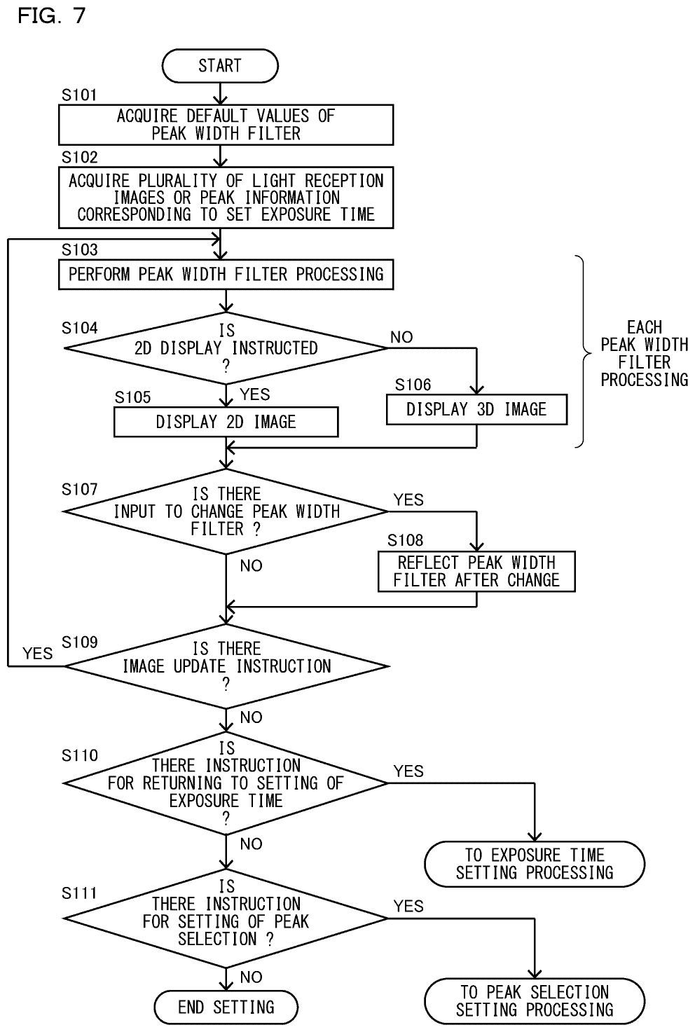

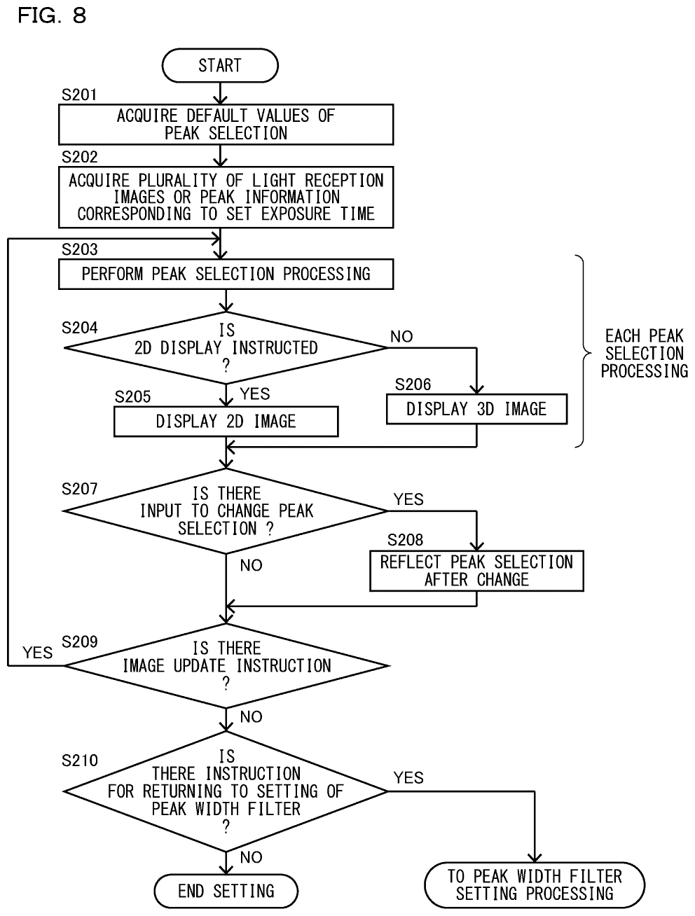

FIG. 6 is a view illustrating a processing flow for setting an exposure time of the optical displacement measurement system 100. FIG. 7 is a view illustrating a processing flow for setting parameters of a peak width filter of the optical displacement measurement system 100. FIG. 8 is a view illustrating a processing flow for setting parameters of peak selection of the optical displacement measurement system 100. The peak width filter is a function of deleting a peak candidate position in the V direction having a wide peak width. The peak selection is a function of selecting a peak position in the V direction from peak candidate positions in the V direction. The parameters of the peak width filter and the parameters of the peak selection are examples of a peak detection parameter.

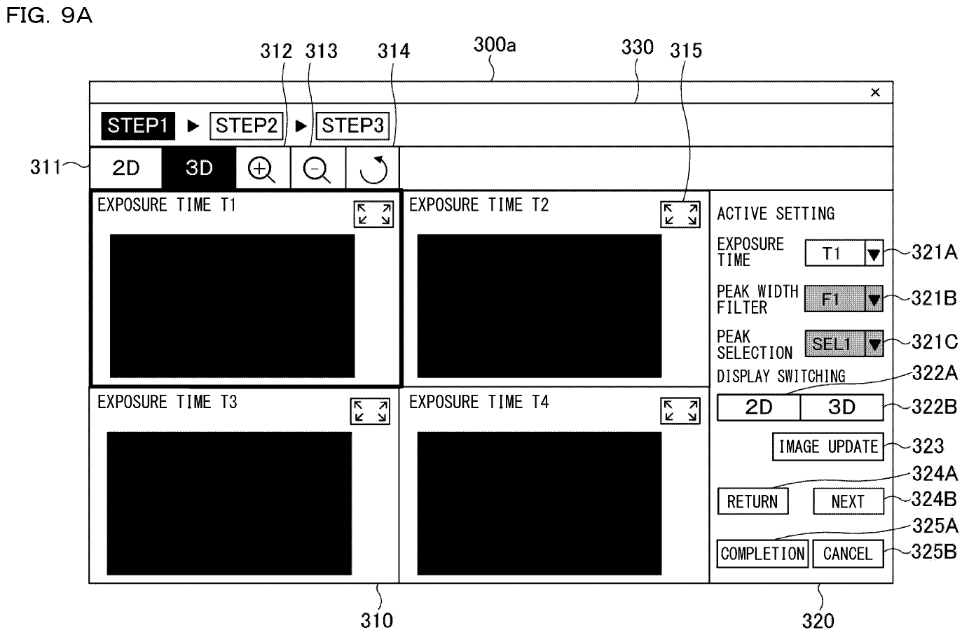

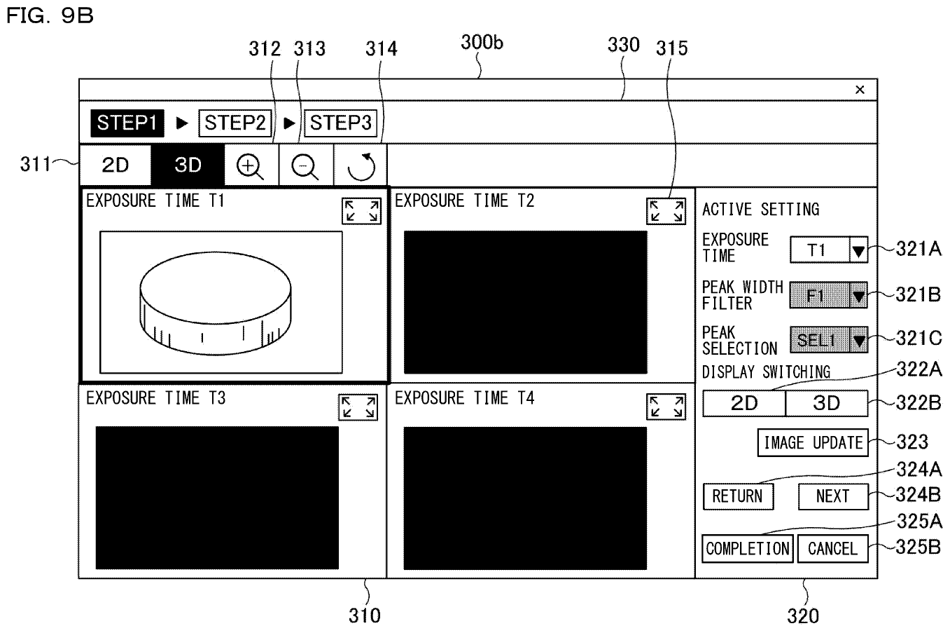

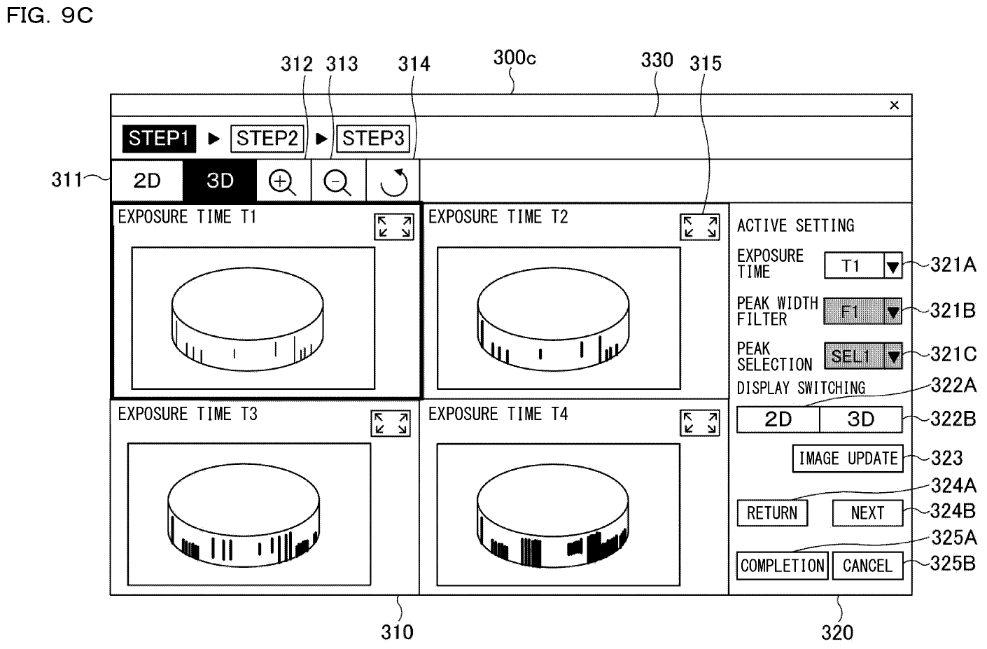

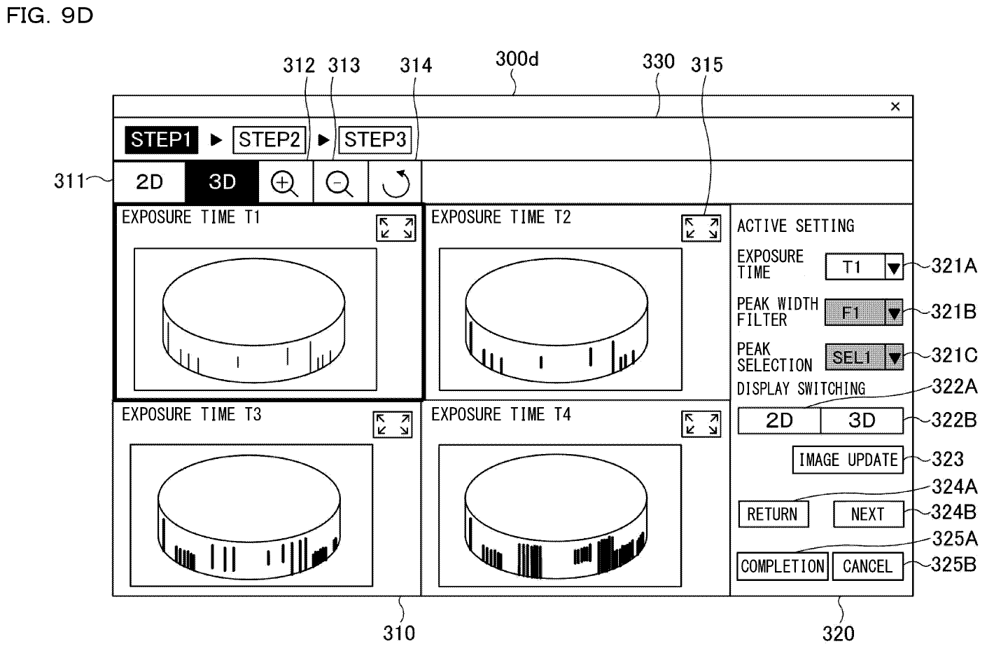

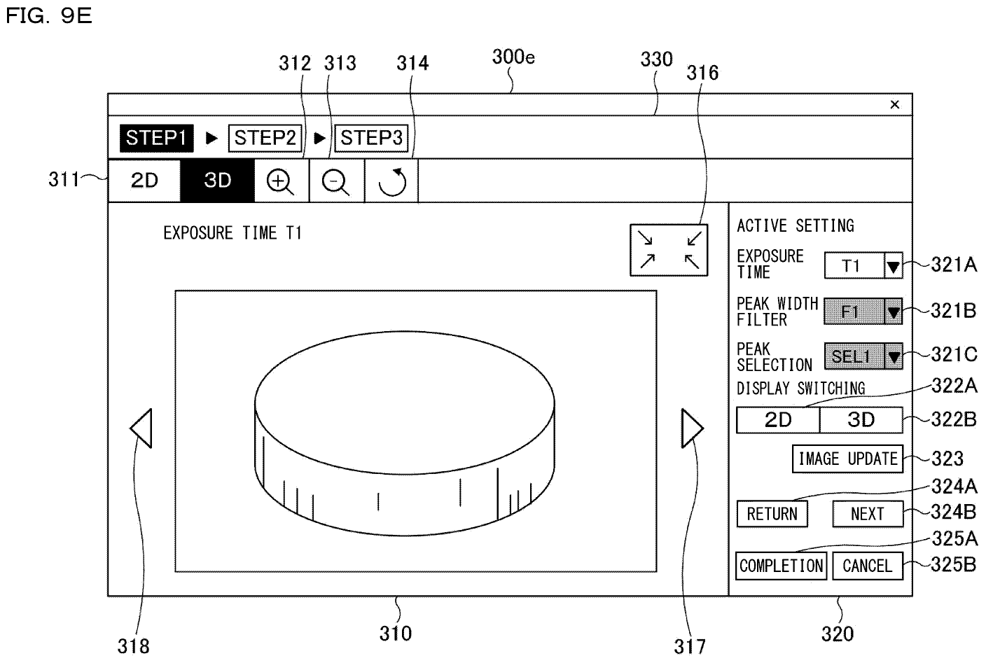

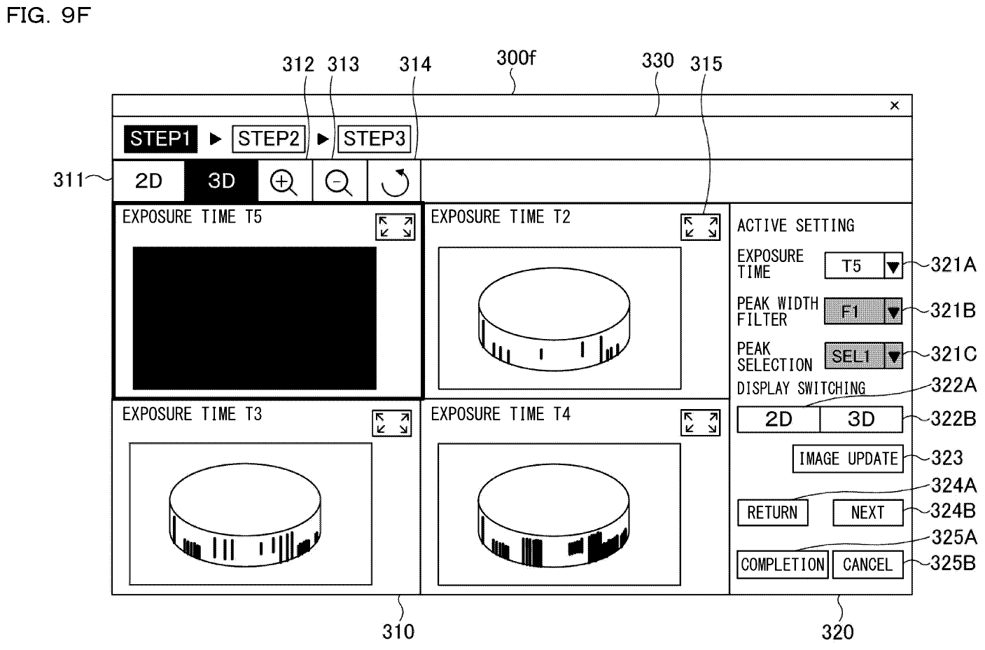

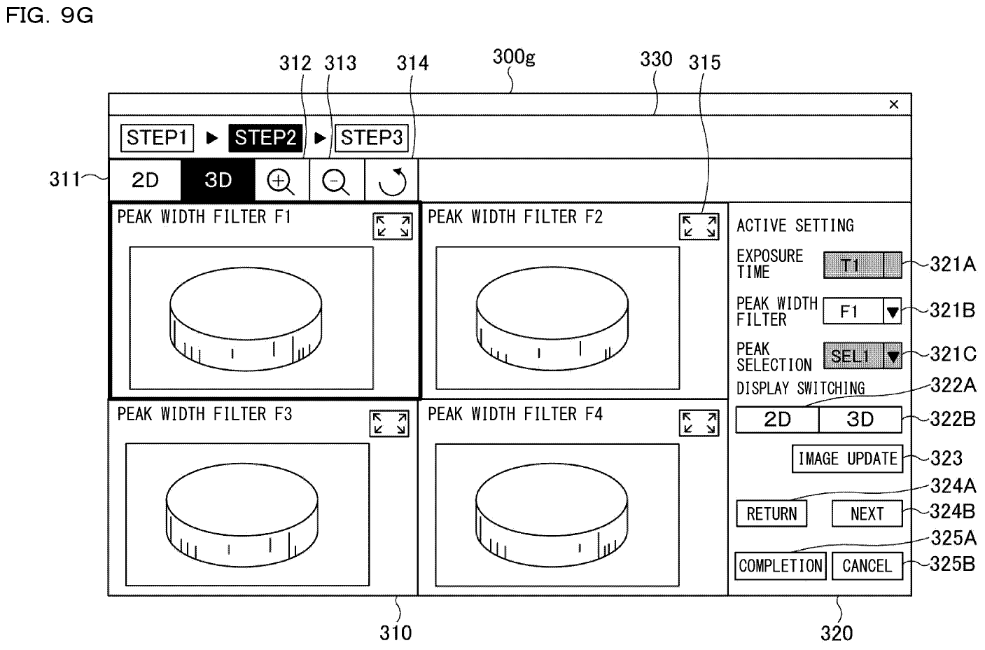

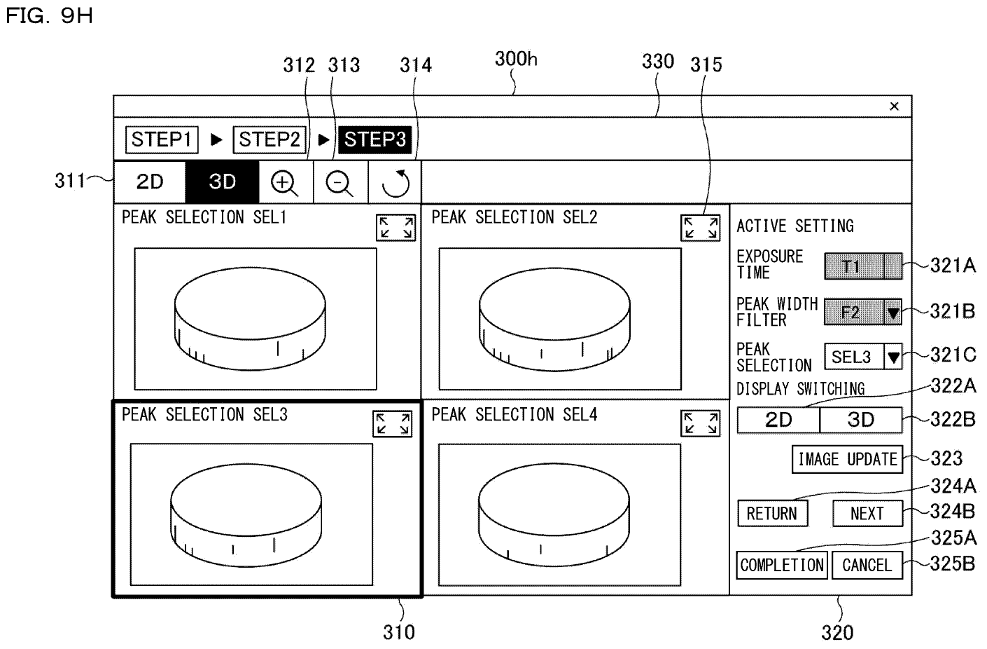

FIGS. 9A to 9H are views illustrating GUIs associated with the processing flows illustrated in FIGS. 6 to 8. When the imaging navigation program is executed by the control device 2, GUIs 300 are displayed on the display device 3. The GUIs 300 (=various setting screens 300a to 300h) associated with the processing flows illustrated in FIGS. 6 to 8 include an image display region 310, an operation region 320, and a progress display region 330 as a basic layout thereof.

In the image display region 310, a distance image (2D image) indicating a height of the workpiece W in the Z direction on an XY plane or a three-dimensional image (3D image) indicating a three-dimensional shape of the workpiece is displayed. The distance image (2D image) is a color image in which a color corresponding to the height of the workpiece W in the Z direction on the XY plane is displayed. Note that the distance image is not limited to the color image, and may be a grayscale image in which a luminance value corresponding to the height is displayed. In addition, an image type display banner 311, an enlargement button 312, a reduction button 313, an angle change button 314, and a maximum display button 315 are attached to the image display region 310. On the image type display banner 311, which of the 2D image and the 3D image is displayed is simply displayed. The enlargement button 312, the reduction button 313, the angle change button 314, and the maximum display button 315 are operated for enlargement, reduction, an angle change, and maximization, respectively, of an image displayed in the image display region 310.

In the operation region 320, an active setting field 321A of the exposure time, an active setting field 321B of the peak width filter, an active setting field 321C of the peak selection, a 2D display switching button 322A, a 3D display switching button 322B, an image update button 323, a return button 324A, a next button 324B, a completion button 325A, and a cancel button 325B are displayed. In the active setting field 321A of the exposure time, the active setting field 321B of the peak width filter, and the active setting field 321C of the peak selection, selection from candidate parameters (parameters stored in the storage unit of the control device 2) is possible using a pull-down menu.

A first step (setting of the exposure time) is executed in the processing flow illustrated in FIG. 6, a second step (setting of the peak width filter) is executed in the processing flow illustrated in FIG. 7, and a third step (setting of the peak selection) is executed in the processing flow illustrated in FIG. 8. In the progress display region 330, the respective steps are displayed in a flow diagram form, and a step that is currently being executed is highlighted. With such a configuration, the user can grasp the progress status of setting work at a glance. Note that the present invention does not necessarily include the three steps. In addition, the contents executed in the respective steps are also not limited to the above, and for example, regarding a measurement condition such as an output intensity of the light source 14 or a detection sensitivity (a threshold of a light receiving amount detected as a peak), an optimum condition may be selected by displaying workpiece images based on different output intensities or detection sensitivities.

The optical displacement measurement system 100 only needs to be configured to be capable of receiving, after the user selects an appropriate exposure time in the first step, adjustment of image processing parameters to be executed for a plurality of light reception images acquired based on the selected exposure time such that more accurate measurement can be performed, and the respective steps are not limited to those illustrated in the flow diagram form as in the progress display region 330. As a result of confirming a workpiece image obtained based on the selected exposure time, the user can execute adjustment if the adjustment of the image processing parameters is necessary, and conversely, can complete setting if the adjustment is unnecessary, so that the setting can be flexibly performed. Note that the image processing parameters may be any of various filters such as expansion, contraction, and averaging, contrast conversion, and interpolation processing using pixel values around an unmeasurable pixel, in addition to the above-described peak detection parameters.

When the optical displacement measurement system 100 is activated for the first time, the imaging navigation program is activated. In addition, the imaging navigation program is also activated when the input device 4 receives a user input for instructing the activation of the imaging navigation program. When the imaging navigation program is activated, the processing flow of FIG. 6 is started.

First, in step S1, the control device 2 acquires a default value of the exposure time from the storage unit. Although it is sufficient to provide a plurality of default values of the exposure time, a case where there are four default values of the exposure time denoted by T1, T2, T3, and T4 will be given as an example in the following description.

In subsequent step S2, the control device 2 acquires other control conditions from the storage unit. Examples of other control conditions include drive control parameters of the motor 21 (a rotation speed of the light projecting/receiving module 20, a rotation angle range of the light projecting/receiving module 20, acceleration/deceleration time of the light projecting/receiving module 20, and the like), and parameters related to imaging other than the exposure time (an output intensity of the light projecting unit 11, a detection sensitivity of the imaging unit 13, a high dynamic range (HDR) parameter, an initial parameter of the peak width filter, an initial parameter of the peak selection, an imaging cycle, and the like). A procedure for determining the drive control parameters of the motor 21 will be described later. When the processes of steps S1 and S2 end, the control device 2 causes the display device 3 to display the setting screen 300a illustrated in FIG. 9A. In the example illustrated in FIG. 9A, the initial parameter of the peak width filter is F1, and the initial parameter of the peak selection is SEL1.

In subsequent step S3, the control unit 22 moves the light projecting/receiving module 20 to a scanning start position. In step S3, the light projecting unit 11 starts irradiation with the slit light L1. When the process of step S3 ends, the flow proceeds to step S4.

The imaging unit 13 captures images at equal time intervals or at equal rotation intervals of the motor 21, for example, as the imaging cycle (step S4), and generates a light reception image in which a vertical direction is the V direction and a horizontal direction is the U direction (step S5). In the case of capturing images at equal rotation intervals, for example, position information of rotation of the motor 21 can be detected by an encoder.

In subsequent step S6, the peak detection unit 241 detects a maximum of N (N is a predetermined integer of two or more) peak candidate positions in the V direction, each of which is equal to or larger than a predetermined luminance value (light receiving amount), based on the initial parameter F1 of the peak width filter at each position in the U direction of the light reception image. When the number of peak candidate positions in the V direction is larger than N, N peak candidate positions are detected in descending order of the luminance value (light receiving amount). Note that the number of detected peak candidate positions in the V direction may be zero.

The processes of steps S4 to S6 described above are executed every capturing cycle of capturing one light reception image.

Then, when an irradiation position of the slit light L1 reaches a scanning end position, the control unit 22 ends the movement of the light projecting/receiving module 20 and ends the relative movement between the workpiece W and the light projecting/receiving module 20 (step S7). In step S7, the light projecting unit 11 ends the irradiation with the slit light L1. When the process of step S7 ends, the flow proceeds to step S8.

In step S8, the peak detection unit 241 selects a peak position in the V direction from the peak candidate positions in the V direction based on the initial parameter SEL1 of the peak selection at each position in the U direction of the light reception image. When the process of step S8 ends, the flow proceeds to step S9.

The profile generation unit 242 converts a profile in the UV coordinate system at each position of the rotation angle θ of the light projecting/receiving module 20 into that in the XYZ coordinate system (step S9), and generates a two-dimensional profile of the XZ cross-section of the workpiece W at each position in the Y direction (step S10). The two-dimensional profile of the XZ cross-section of the workpiece W at each position in the Y direction is the XYZ coordinate information indicating the shape of the workpiece W. When the process of step S10 ends, the flow proceeds to step S11.

In step S11, the control device 2 determines whether 2D display is instructed based on a user input received by the input device 4. When the 2D display is instructed (YES in step S11), the display device 3 displays the 2D image generated based on the XYZ coordinate information indicating the shape of the workpiece W (step S12). On the other hand, when the 2D display is not instructed (NO in step S11), the display device 3 displays the 3D image generated based on the XYZ coordinate information indicating the shape of the workpiece W (step S13). For example, it is sufficient for the user to instruct the 2D display in a case where it is desired to perform confirmation of an unmeasured location (invalid pixel) or observation in the unit of one pixel, and to instruct the 3D display in a case where it is desired to perform, for example, intuitive confirmation of the shape or confirmation of the presence or absence of a point (noise) having a different height. In the following description, a case where the 2D display is not instructed will be described as an example.

The processes of steps S3 to S13 described above are executed for each exposure time. Therefore, at a point in time when the processes of steps S3 to S13 for the exposure time T1 end, the control device 2 causes the display device 3 to display the setting screen 300b illustrated in FIG. 9B. At a point in time when the processes of steps S3 to S13 for the exposure times T1, T2, T3, and T4 end, the control device 2 causes the display device 3 to display the setting screen 300c illustrated in FIG. 9C.

The scanning start position in step S3 may be the same for all of the exposure times T1, T2, T3, and T4. Alternatively, the scanning end position for the exposure time T1 may be the scanning start position for the exposure time T2, the scanning end position for the exposure time T2 may be the scanning start position for the exposure time T3, and the scanning end position for the exposure time T3 may be the scanning start position for the exposure time T4. In the latter case, there is a possibility that positional deviation between a scanning end position and a next scanning start position occurs, but the positional deviation is minor, and the respective measurement ranges in the respective exposure times include a common range.

Since the display of the 2D image or the 3D image acquired is automated for each of different exposure times, it is possible to reduce time and effort until the user selects an appropriate exposure time.

Note that the processes of steps S3 to S13 for the exposure time t2 may be started after the processes of steps S3 to S13 for the exposure time t1 end, but step S3 in the exposure time T2 may be started between the end of step S7 and the end of the process of step S13 for the exposure time T1. The latter, so-called parallel processing, can speed up setting processing.

On the setting screen 300c illustrated in FIG. 9C, the exposure time T1 is set to be active, and the enlargement button 312, the reduction button 313, the angle change button 314, the maximum display button 315, the 2D display switching button 322A, and the 3D display switching button 322B are enabled for the 3D image in the exposure time T1.

When the 3D image in the exposure time T1 is enlarged by clicking the enlargement button 312, the respective 3D images in the exposure times T2, T3, and T4 are also enlarged under the same display conditions as those of the 3D image in the exposure time T1, and a transition is made from the setting screen 300c illustrated in FIG. 9C to the setting screen 300d illustrated in FIG. 9D.

The same applies to the reduction button 313, the angle change button 314, the 2D display switching button 322A, and the 3D display switching button 322B, and when each of various types of processing for one image corresponding to the active setting is instructed, the same processing is applied to the remaining images not corresponding to the active setting.

In addition, when the maximum display button 315 attached to the 3D image in the exposure time T1 is clicked on the setting screen 300c illustrated in FIG. 9C, a transition is made to the setting screen 300e illustrated in FIG. 9E.

On the setting screen 300e illustrated in FIG. 9E, a minimum display button 316, a forward button 317, and a reverse button 318 are displayed in the image display region 310. When the minimum display button 316 is clicked, a transition is made from the setting screen 300e illustrated in FIG. 9E to the setting screen 300c illustrated in FIG. 9C. When the forward button 317 is clicked on the setting screen 300e illustrated in FIG. 9E, the maximally displayed 3D image in the exposure time T1 is switched to the maximally displayed 3D image in the exposure time T2, and the maximally displayed 3D image in the exposure time T2 becomes an image corresponding to the active setting. When the reverse button 318 is clicked on the setting screen 300e illustrated in FIG. 9E, the maximally displayed 3D image in the exposure time T1 is switched to the maximally displayed 3D image in the exposure time T4, and the maximally displayed 3D image in the exposure time T4 becomes an image corresponding to the active setting.

When the enlargement button 312, the reduction button 313, the angle change button 314, the 2D display switching button 322A, or the 3D display switching button 322B is clicked on the setting screen 300e illustrated in FIG. 9E so that each of various types of processing for one image corresponding to the active setting is instructed, the same processing is applied to the remaining images (not displayed on the setting screen 300e) not corresponding to the active setting.

When the processes of steps S3 to S13 described above for each exposure time end, the flow proceeds to step S14.

In step S14, the control device 2 determines whether there is an input to change the exposure time based on a user input received by the input device 4. Note that the input to change the exposure time may be received before step S3.

For example, when T5 is input in the active setting field 321A of the exposure time on the setting screen 300c illustrated in FIG. 9C, the control device 2 determines that there is the input to change the exposure time (YES in step S14), and changes the exposure time T1 to the exposure time T5 and causes the display device 2 to display the setting screen 300f illustrated in FIG. 9F. Then, the control device 2 causes the optical displacement meter 1 to perform only imaging for the changed exposure time T5 (step S16).

In a case where the control device 2 determines that there is no input to change the exposure time (NO in step S14) or in a case where the process of step S16 ends, the flow proceeds to step S17.

In step S17, the control device 2 determines whether there is an image update instruction based on whether the image update button 323 is clicked. In a case where the control device 2 determines that there is the image update instruction (YES in step S17), the flow returns to step S3. On the other hand, in a case where the control device 2 determines that there is no image update instruction (NO in step S17), the flow proceeds to step S18.

In step S18, the control device 2 determines whether there is an instruction for the setting of the peak width filter based on whether the next button 324B is clicked.

When the next button 324B is clicked, it is determined that there is the instruction for the setting of the peak width filter (YES in step S18), and the flow proceeds to the processing flow of FIG. 7.

When the completion button 325A is clicked, it is determined that there is no instruction for the setting of the peak width filter (NO in step S18), the active setting of the exposure time is settled as a parameter of the exposure time, and the setting is ended. When the cancel button 325B is clicked, it is determined that there is no instruction for the setting of the peak width filter (NO in step S18), and the setting is ended without settling the active setting of the exposure time as the parameter of the exposure time.

In step S101 in the processing flow of FIG. 7, the control device 2 acquires default values of the peak width filter from the storage unit. Although it is sufficient to provide a plurality of default values of the peak width filter, a case where there are four default values of the peak width filter denoted by F1, F2, F3, and F4 will be given as an example in the following description.

In subsequent step S102, the control device 2 reads a plurality of light reception images corresponding to the exposure time (here, T1) set in the processing flow of FIG. 6 or peak candidate information acquired from the plurality of light reception images from the storage unit. The peak candidate information is information including positions and peak widths of peak candidates. Since the capacity of the storage unit is under pressure if all of the light reception images are stored, it is sufficient to store only information required to execute peak detection processing.

In subsequent step S103, the control device 2 performs peak width filter processing on the plurality of light reception images corresponding to the exposure time set in the processing flow of FIG. 6 or the peak candidate information acquired from the plurality of light reception images. Note that, in steps S102 and S103, imaging may be executed again as in steps S3 to S6 based on the settled parameter of the exposure time, and then the peak width filter may be performed on newly obtained light reception images.

In subsequent step S104, the control device 2 determines whether the 2D display is instructed based on a user input received by the input device 4. When the 2D display is instructed (YES in step S104), the display device 3 displays the 2D image generated based on the XYZ coordinate information indicating the shape of the workpiece W (step S105). On the other hand, when the 2D display is not instructed (NO in step S105), the display device 3 displays the 3D image generated based on the XYZ coordinate information indicating the shape of the workpiece W (step S106).

The processes of steps S103 to S106 described above are executed for each parameter of the peak width filter. Therefore, at a point in time when the processes of steps S103 to S106 for the default values F1, F2, F3, and F4 of the peak width filter end, the control device 2 causes the display device 3 to display the setting screen 300g illustrated in FIG. 9G.

When the processes of steps S103 to S106 described above for each parameter of the peak width filter end, the flow proceeds to step S107.

In step S107, the control device 2 determines whether there is an input to change the parameter of the peak width filter based on a user input received by the input device 4. Note that the input to change the parameter of the peak width filter may be received before step S103.

For example, when F5 is input in the active setting field 321B of the peak width filter on the setting screen 300g illustrated in FIG. 9G, the control device 2 determines that there is the input to change the parameter of the peak width filter (YES in step S107), and changes the parameter F1 of the peak width filter to the parameter F5 of the peak width filter (step S108).

In a case where the control device 2 determines that there is no input to change the parameter of the peak width filter (NO in step S107) or in a case where the process of step S108 ends, the flow proceeds to step S109.

In step S109, the control device 2 determines whether there is an image update instruction based on whether the image update button 323 is clicked. In a case where the control device 2 determines that there is the image update instruction (YES in step S109), the flow returns to step S103. On the other hand, in a case where the control device 2 determines that there is no image update instruction (NO in step $109), the flow proceeds to step S110.

In step S110, the control device 2 determines whether there is an instruction for returning to the setting of the exposure time based on whether the return button 324A is clicked.

When the return button 324A is clicked, it is determined that there is the instruction for returning to the setting of the exposure time (YES in step S110), and the flow returns to the processing flow of FIG. 6.

When the return button 324A is not clicked, it is determined that there is no instruction for returning to the setting of the exposure time (NO in step S110), and the flow proceeds to step S111.

In step S111, the control device 2 determines whether there is an instruction for the setting of the peak selection based on whether the next button 324B is clicked.

When the next button 324B is clicked, it is determined that there is the instruction for the setting of the peak selection (YES in step S111), and the flow proceeds to the processing flow of FIG. 8.

When the completion button 325A is clicked, it is determined that there is no instruction for the setting of the peak selection (NO in step S111), the active setting of the peak width filter is settled as the parameter of the peak width filter, and the setting is ended. When the cancel button 325B is clicked, it is determined that there is no instruction for the setting of the peak selection (NO in step S111), and the setting is ended without settling the active setting of the peak width filter as the parameter of the peak width filter.

In step S201 in the processing flow of FIG. 8, the control device 2 acquires default values of the peak selection from the storage unit. Although it is sufficient to provide a plurality of default values of the peak selection, a case where there are four default values of the peak selection denoted by SEL1, SEL2, SEL3, and SEL4 will be given as an example in the following description.

In subsequent step S202, the control device 2 reads a plurality of light reception images corresponding to the exposure time (here, T1) set in the processing flow of FIG. 6 or peak candidate information acquired from the plurality of light reception images from the storage unit.

In subsequent step S203, the control device 2 performs the peak width filter processing set in the processing flow of FIG. 7 on the plurality of light reception images corresponding to the exposure time set in the processing flow of FIG. 6 or the peak candidate information acquired from the plurality of light reception images, and further performs the peak selection. Note that, in steps S102 and S103, imaging may be executed again as in steps S3 to S6 based on the settled parameter of the exposure time, and then the peak width filter and peak selection processing may be performed on newly obtained light reception images.

In subsequent step S204, the control device 2 determines whether the 2D display is instructed based on a user input received by the input device 4. When the 2D display is instructed (YES in step S204), the display device 3 displays the 2D image generated based on the XYZ coordinate information indicating the shape of the workpiece W (step S205). On the other hand, when the 2D display is not instructed (NO in step S205), the display device 3 displays the 3D image generated based on the XYZ coordinate information indicating the shape of the workpiece W (step S206).

The processes of steps S203 to S206 described above are executed for each parameter of the peak selection. Therefore, at a point in time when the processes of steps S203 to S206 for the default values SEL1, SEL2, SEL3, and SEL4 of the peak selection end, the control device 2 causes the display device 3 to display the setting screen 300h illustrated in FIG. 9H.

When the processes of steps S203 to S206 described above for each parameter of the peak selection end, the flow proceeds to step S207.

In step S207, the control device 2 determines whether there is an input to change the parameter of the peak selection based on a user input received by the input device 4. Note that the input to change the parameter of the peak selection may be received before step S203.

For example, when SEL5 is input in the active setting field 321B of the peak selection on the setting screen 300h illustrated in FIG. 9H, the control device 2 determines that there is the input to change the parameter of the peak selection (YES in step S207), and changes the parameter SEL3 of the peak selection to the parameter SEL5 of the peak selection (step S208).

In a case where the control device 2 determines that there is no input to change the parameter of the peak selection (NO in step S207) or in a case where the process of step S208 ends, the flow proceeds to step S209.

In step S209, the control device 2 determines whether there is an image update instruction based on whether the image update button 323 is clicked. In a case where the control device 2 determines that there is the image update instruction (YES in step S209), the flow returns to step S203. On the other hand, in a case where the control device 2 determines that there is no image update instruction (NO in step S209), the flow proceeds to step S210.

In step S120, the control device 2 determines whether there is an instruction for returning to the setting of the peak width filter based on whether the return button 324A is clicked.

When the return button 324A is clicked, it is determined that there is the instruction for returning to the setting of the peak width filter (YES in step S210), and the flow returns to the processing flow of FIG. 7.

When the return button 324A is not clicked, it is determined that there is no instruction for returning to the setting of the peak width filter (NO in step S210). When the completion button 325A is clicked, the active setting of the peak selection is settled as the parameter of the peak selection, and the setting is ended. When the cancel button 325B is clicked, and the setting is ended without settling the active setting of the peak selection as the parameter of the peak selection.

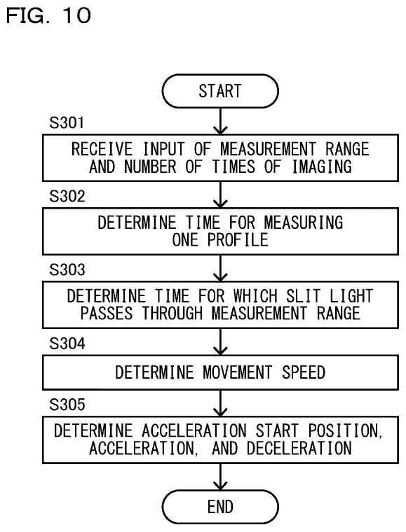

FIG. 10 is a flowchart illustrating a procedure for determining the drive control parameters of the motor 21.

In step S301, the control device 2 inputs a measurement range (a range defined by a rotation range of the light projecting/receiving module 20 in the present embodiment, and defined by a movement range of the workpiece W in the Y direction in a second embodiment to be described later) and the number of times of imaging based on a user input received by the input device 4. Note that an imaging frequency (one-time imaging per predetermined range) may be input instead of the measurement range or the number of times of imaging.

In subsequent step S302, the control device 2 determines a time for which one two-dimensional cross-sectional profile is measured. The time for which one two-dimensional cross-sectional profile is measured is determined according to a longer one of the exposure time and a reading time of the imaging unit 13.

In subsequent step S303, the control device 2 determines a time for which the slit light L1 passes through the measurement range (a scanning time required for scanning the measurement range) based on the number of times of imaging received in step S301 and the time for which one two-dimensional cross-sectional profile is measured determined in step S302.

In subsequent step S304, the control device 2 determines a movement speed (defined by the rotation speed of the light projecting/receiving module 20 in the present embodiment, and by a movement speed of the workpiece W in the Y direction in the second embodiment to be described later) based on the measurement range received in step S301 and the scanning time determined in step S303.

Finally, in step S305, the control device 2 determines an acceleration start position and an acceleration such that the movement speed determined in step S304 is reached at a measurement start position, and determines a deceleration from the movement speed determined in step S304 so as to enable a stop at a predetermined position at a measurement end position. As a result, it is possible to set the drive control parameters optimal for the measurement condition of the user, and thus, it is possible to shorten the time required for the setting, for example.

Parameters received in the flowchart of FIG. 10 and parameters determined in the flowchart of FIG. 10 are stored in the storage unit of the control device 2.

### Second Embodiment

### <Optical Displacement Measurement System>

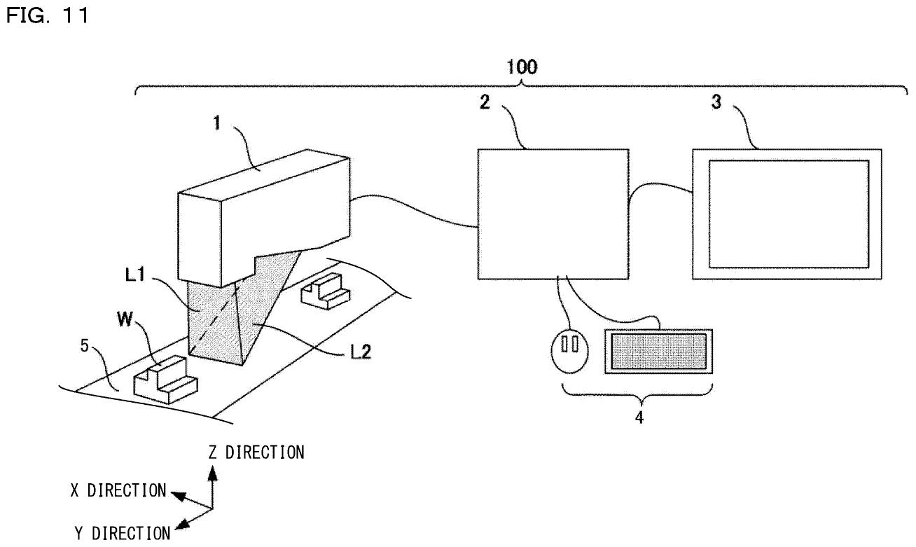

FIG. 11 is a diagram illustrating a schematic configuration example of an optical displacement measurement system according to a second embodiment. An optical displacement measurement system 100 illustrated in FIG. 11 includes an optical displacement meter 1, a control device 2, a display device 3, an input device 4, and a belt conveyor 5.

In the present embodiment, an X direction corresponds to a width direction of slit light L1 output from the optical displacement meter 1, a Z direction corresponds to a height direction of a workpiece W, and a Y direction is a direction orthogonal to the X direction and the Z direction. A XZ plane to be described later is a plane extending in the X direction and the Z direction.

The optical displacement measurement system 100 is a system that measures a profile and a three-dimensional shape of the workpiece W conveyed in the Y direction by the belt conveyor 5. The profile of the workpiece W is data indicating an outer edge of a cut surface of the workpiece W by the slit light L1. When the slit light is emitted in parallel to the XZ plane, the profile of the workpiece W is data indicating an outer edge of a cut surface parallel to the XZ plane, and thus, is also referred to as a two-dimensional profile of a XZ cross-section of the workpiece W.

For example, the profile is an aggregate of (xi, zi) (i is an index). “xi” indicates a position in the X direction. “zi” indicates a height in the Z direction. Note that the three-dimensional shape is an aggregate of (xi, yi, zi). “yi” indicates a position in the Y direction.

The optical displacement meter 1 operates in accordance with an instruction from the control device 2. The optical displacement meter 1 outputs the slit light L1 extending in the X direction and receives reflected light L2 from the workpiece W. Then, the optical displacement meter 1 calculates a profile of the workpiece W based on a light reception result. The optical displacement meter 1 captures images at regular intervals to generate profiles of the workpiece W having different values of yi. In addition, the optical displacement meter 1 generates three-dimensional shape data of the workpiece W from the profiles of the workpiece W having different values of yi.

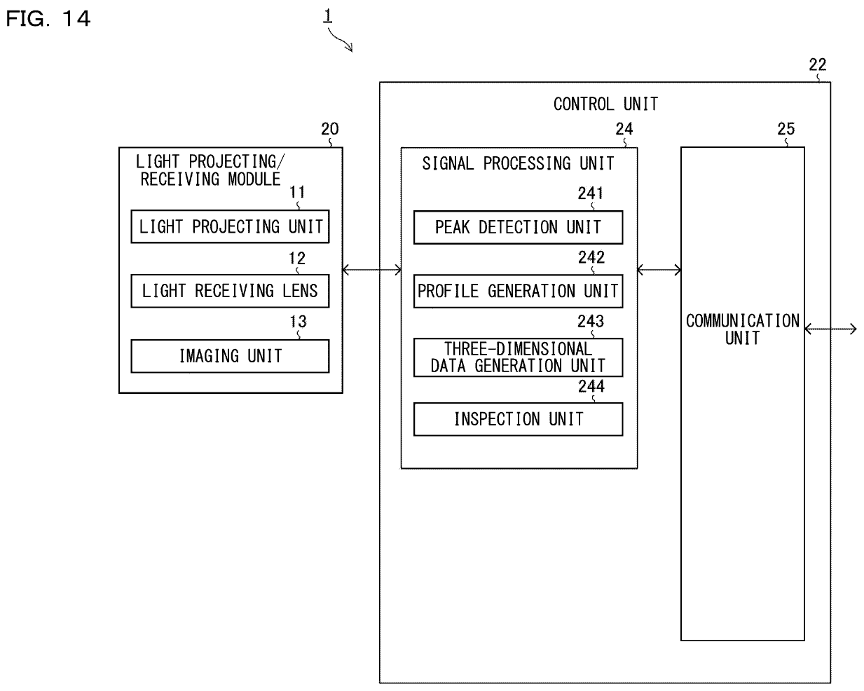

The control device 2 outputs an instruction based on a user input received by the input device 4 to the optical displacement meter 1, and receives a measurement result of the workpiece W from the optical displacement meter 1. In addition, the control device 2 outputs a display signal to the display device 3. The control device 2 is, for example, a personal computer, a programmable logic control unit, or the like. The control device 2 is also a setting device configured to set control conditions of the light projecting/receiving module 20 (see FIG. 14 to be described later) and the belt conveyor 5 (a moving mechanism for relatively moving the light projecting/receiving module 20 and the workpiece W). In a case where the input device 4 is operated by the user, the control device 2 detects the operation, and receives the setting of control conditions of the light projecting/receiving module 20 and a motor for driving the belt conveyor 5. The control device 2 includes a storage unit, and the storage unit stores a program (imaging navigation program) for setting the control conditions of the light projecting/receiving module 20 and the belt conveyor 5, default settings of the control conditions of the light projecting/receiving module 20 and the belt conveyor 5, XYZ coordinate information indicating a shape of the workpiece W, and the like.

The display device 3 displays, for example, the measurement result of the workpiece W, a user interface (UI) for setting the optical displacement meter 1, and the like based on the display signal from the control device 2.

The input device 4 receives the user input with respect to the optical displacement measurement system 100. In FIG. 1, a keyboard and a mouse are illustrated as the input device 4. However, the input device 4 is not limited to the keyboard and the mouse. For example, the input device 4 may be a touch panel disposed on a display screen of the display device 3.

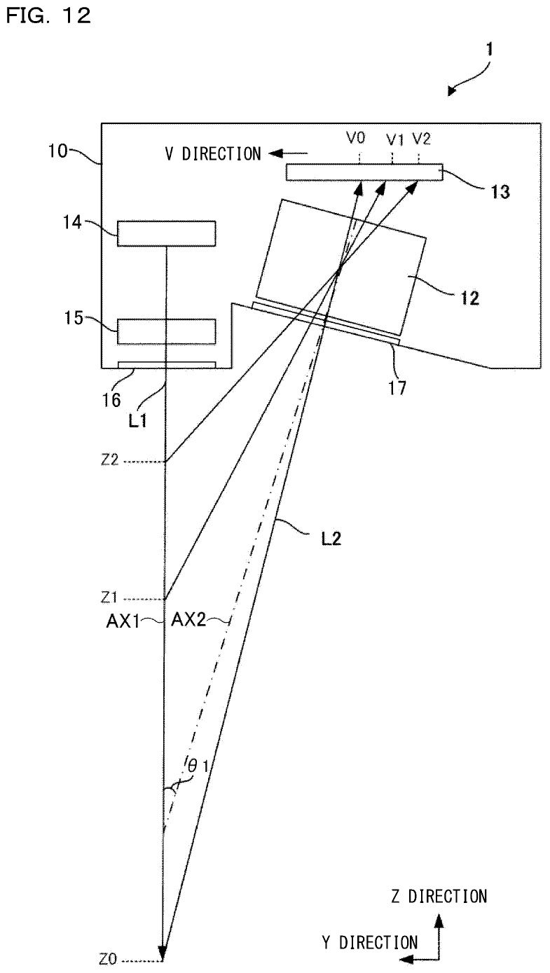

FIG. 12 is a view illustrating the principle of a light sectioning method (triangulation). A light projecting unit 11, a light receiving lens 12, and a imaging unit 13 are built in a housing 10 of the optical displacement meter 1. The light projecting unit 11 includes a light source 14 and a light projecting lens 15. For example, the light source 14 may be a laser light emitter, and the light projecting lens 15 may include a plurality of lenses including a cylindrical lens. Light output from the light source 14 passes through the light projecting lens 15 and is converted into the slit light L1. The housing 10 is provided with a light projecting window 16 through which the slit light L1 passes. Similarly, the housing 10 is provided with a light receiving window 17 for guiding the reflected light L2 to the inside of the housing 10.

The light receiving lens 12 is a lens for forming an image of the reflected light L2 on the imaging unit 13. The imaging unit 13 is a sensor having a plurality of pixels (which may be referred to as light receiving elements or photoelectric conversion elements) arranged two-dimensionally. As illustrated in FIG. 12, a light reception axis AX2 of the imaging unit 13 is inclined by an angle θ1 with respect to a light projection axis AX1 of the light source 14. That is, the reflected light L2 from a height Z0 forms an image at a position V0 in the V direction of the imaging unit 13. The reflected light L2 from a height Z1 forms an image at a position V1 in the V direction of the imaging unit 13. The reflected light L2 from a height Z2 forms an image at a position V2 in the V direction of the imaging unit 13. In this manner, the V direction of the imaging unit 13 corresponds to the Z direction of the workpiece W. Although a U direction of the imaging unit 13 is not illustrated, the U direction corresponds to the X direction of the workpiece W. That is, a vertical direction of an image, which is a light reception result output by the imaging unit 13, is the V direction, and a horizontal direction thereof is the U direction.

Although the light source 14 is disposed such that the slit light L1 is output in a Z direction in FIG. 12, a positional relationship between a pair of the light source 14 and the light projecting lens 15 and a pair of the imaging unit 13 and the light receiving lens 12 may be reversed.

### <Position (Calculation of Height)>

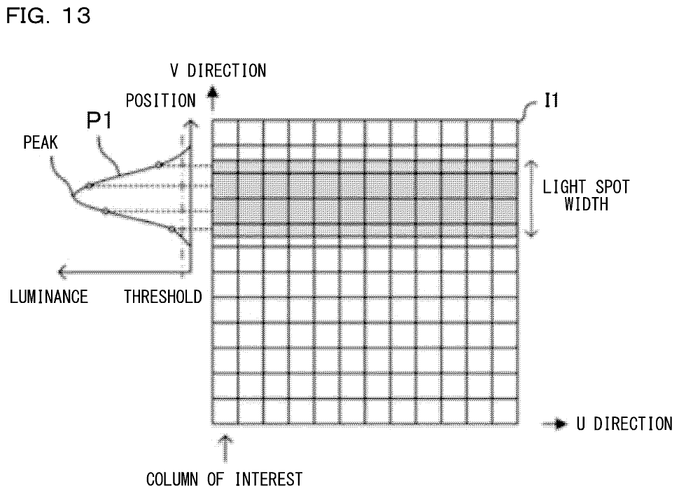

FIG. 13 is a view for describing a method of calculating a height forming a profile from an image I1 that is a light reception result output by the imaging unit 13. The slit light L1 has a certain width in the Y direction. Therefore, a width of a light spot formed by the reflected light L2 on the light receiving surface of the imaging unit 13 is also a width that spans the plurality of photoelectric conversion elements.

Therefore, the optical displacement meter 1 obtains an approximate curve P1 indicating a change in a luminance value from luminance values of pixels, and calculates a position in the V direction at which a peak value is obtained in the approximate curve P1. In FIG. 13, the leftmost column is a column of interest, and the distribution (approximate curve P1) of luminance values of the column of interest is illustrated. The approximate curve P1 is obtained by curve fitting or the like of a plurality of sample values. A sample value below a detection threshold is not considered. The position in the V direction at which the peak value is obtained indicates a height of the workpiece W. The optical displacement meter 1 obtains the approximate curve P1 at each position (each pixel column) in the U direction, and calculates the position (height) in the V direction at which the peak value is obtained from the approximate curve P1. This calculation processing is executed at each position in the U direction, thereby obtaining one profile. Such calculation processing may be referred to as subpixel processing.

Note that, for example, a coordinate conversion condition (for example, a coordinate conversion table) indicating a correspondence relationship among UV coordinates, a relative position y between the optical displacement meter 1 and the workpiece W in the Y direction, and local coordinates (X, Y, Z) and expressed by (U, V, θ)=(X, Y, Z) is generated by calibration before shipment, and is stored in a storage unit (not illustrated) of the optical displacement meter 1, and thus, the optical displacement meter 1 can convert a profile in a UV coordinate system into a profile in an XYZ coordinate system based on the relative position y between the optical displacement meter 1 and the workpiece W in the Y direction by simple calculation. Note that, in the coordinate conversion, equal interval correction in the X direction and the Y direction may be executed such that positions in the X direction and the Y direction are plotted at equal intervals, and a Z coordinate corresponding to the corrected (X, Y) may be obtained by linear interpolation or the like and output as a measurement result. Image processing to be performed on the measurement result is often based on data sampled at equal intervals in the X direction and the Y direction, and thus the subsequent image processing is facilitated by the equal interval correction.

### <Functional Blocks>

FIG. 14 is a functional block diagram of the optical displacement meter 1. The optical displacement meter 1 includes a light projecting/receiving module 20 and a control unit 22.

The light projecting/receiving module 20 holds the light projecting unit 11, the light receiving lens 12, and the imaging unit 13 in an integrated manner.

The control unit 22 includes a signal processing unit 24 and a communication unit 25. The signal processing unit 24 controls the light projecting unit 11 to emit the slit light L1 from the light projecting unit 11.

The signal processing unit 24 includes a peak detection unit 241, a profile generation unit 242, a three-dimensional data generation unit 243, and an inspection unit 244.

The peak detection unit 241 detects positions (peak positions) in the V direction having peaks of luminance values based on light reception results output from the imaging unit 13. The profile generation unit 242 generates one piece of profile data by collecting heights (zi) of the workpieces W at the respective positions (xi) in the X direction obtained by the peak detection unit 241. The three-dimensional data generation unit 243 generates three-dimensional shape data of the workpiece W from profiles of the workpieces W having different values of yi and generated by the profile generation unit 242.

The inspection unit 244 inspects the workpiece W based on the three-dimensional shape data of the workpiece W generated by the three-dimensional data generation unit 243. The inspection unit 244 performs predetermined measurement on the three-dimensional shape data of the workpiece W, and inspects the workpiece W based on a result of the measurement. For example, the inspection unit 244 measures a length, an angle, and the like of a predetermined portion of the workpiece W. Then, the inspection unit 244 determines whether the workpiece W is a non-defective product based on these measurement results, preset thresholds, and the like.

Note that at least some of the peak detection unit 241, the profile generation unit 242, the three-dimensional data generation unit 243, and the inspection unit 244 may be provided at a place separated from a main body of the optical displacement meter 1 (for example, inside the control device 2 illustrated in FIG. 11). In this case, the optical displacement meter 1 has a separate structure including the main body of the optical displacement meter 1 and a separate portion of the optical displacement meter 1.

The communication unit 25 performs wired or wireless communication with the control device 2. For example, the communication unit 25 receives an instruction from the control device 2 and transmits the instruction to the control unit 22. In addition, the communication unit 25 transmits, for example, the profile data and the three-dimensional shape data of the workpiece W generated by the signal processing unit 24 and an inspection result of the workpiece W determined by the inspection unit 244 to the control device 2.

### <Processing Flow>

The motor 21 of the first embodiment is replaced with a motor for driving the belt conveyor 5 in the present embodiment, and a scanning direction is a direction (Y direction) in which the workpiece W is conveyed by the belt conveyor 5 in the present embodiment, instead of a rotation direction of the light projecting/receiving module 20 in the first embodiment. Therefore, the processing flows illustrated in FIGS. 6 to 8 can also be applied to the present embodiment by changing the motor and changing the contents of coordinate conversion.

### Modified Example of Relative Movement

In the optical displacement measurement system 100 illustrated in FIG. 11, a profile and a three-dimensional shape of the workpiece W are measured as the workpiece W is moved in the Y direction relative to the light projecting/receiving module 20 of the optical displacement meter 1 by the belt conveyor 5. Although the workpiece W moves in the present embodiment, the relative movement between the workpiece W and the light projecting/receiving module 20 of the optical displacement meter 1 is not limited thereto. Therefore, the light projecting/receiving module 20 of the optical displacement meter 1 may be moved without moving the workpiece W, or both the workpiece W and the light projecting/receiving module 20 of the optical displacement meter 1 may be moved.

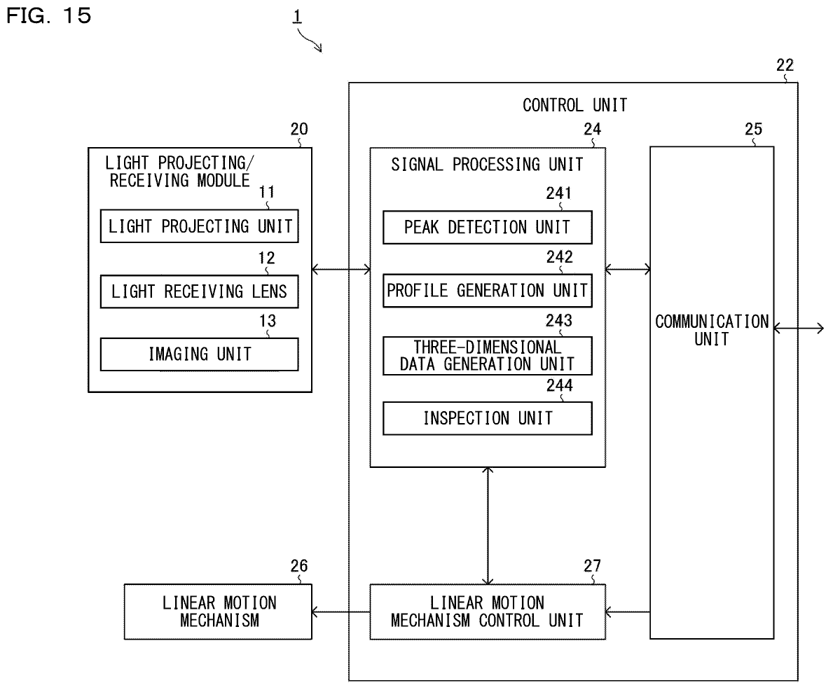

In a case where the light projecting/receiving module 20 of the optical displacement meter 1 is moved, as illustrated in FIG. 15, the optical displacement meter 1 includes a linear motion mechanism 26, and the control unit 22 includes a linear motion mechanism control unit 27. The linear motion mechanism control unit 27 controls the linear motion mechanism 26 to move the light projecting/receiving module in the Y direction in the housing 10.

### Others

Note that, in addition to the above-described embodiments, various alterations can be applied to various technical features disclosed in the present specification within a scope not departing from the spirit of the technical creation. That is, it should be considered that the above-described embodiments are illustrative in all respects and not restrictive. In addition, the technical scope of the present invention is defined by the claims, and should be understood to include all modifications falling within the meaning and scope equivalent to the claims.

For example, the setting of the exposure time, the setting of the peak width filter, and the setting of the peak selection are performed in stages in the above-described embodiments, but the setting of the exposure time and the setting of the peak width filter may be performed collectively, or the setting of the exposure time, the setting of the peak width filter, and the setting of the peak selection may be performed collectively.

In a case where the setting of the exposure time and the setting of the filter width filter are collectively performed, for example, when there are four choices for the exposure time, it is sufficient to perform the peak width filter processing with each parameter of the peak width filter on a plurality of light reception images acquired in a first exposure time, thereafter perform the peak width filter processing with each parameter of the peak width filter on a plurality of light reception images acquired in a second exposure time, thereafter perform the peak width filter processing with each parameter of the peak width filter on a plurality of light reception images acquired in a third exposure time, and finally perform the peak width filter processing with each parameter of the peak width filter on a plurality of light reception images acquired in a fourth exposure time.

In addition, for example, the storage unit of the control device 2 may store different default control conditions respectively corresponding to measured distances of the light projecting/receiving module 20 and an input field for the measured distance of the light projecting/receiving module may be provided on the GUI 300 such that the imaging navigation program can support a plurality of types of the optical displacement meters 1. In this case, it is sufficient for the control device 2 to read a corresponding default control condition from the storage unit when an input of a measured distance of the light projecting/receiving module 20 is received via the GUI 300.

What is claimed is:

1. An optical displacement measurement system comprising:
a light projecting/receiving module including a light projecting unit that irradiates a workpiece with slit light extending in an X direction and an image sensor that includes a plurality of pixels two-dimensionally arranged in a U direction corresponding to the X direction and a V direction orthogonal to the U direction, receives reflected light reflected from the workpiece by the plurality of pixels, and outputs a light reception image indicating a light receiving amount distribution;
a moving mechanism that relatively moves the light projecting/receiving module and the workpiece;
a setting device configured to set control conditions of the light projecting/receiving module and the moving mechanism; and
a control unit that controls the light projecting/receiving module and the moving mechanism based on the control conditions,
wherein the control conditions include a plurality of exposure times, different from each other, of the image sensor,
the control unit
controls the light projecting/receiving module to sequentially acquire a plurality of the light reception images of the workpiece based on each of the plurality of exposure times while causing the moving mechanism to relatively move the light projecting/receiving module and the workpiece within each of measurement ranges including at least a common range,
acquires XYZ coordinate information indicating a shape of the workpiece based on the plurality of light reception images for each of the plurality of exposure times to generate a workpiece image indicating the shape of the workpiece based on the XYZ coordinate information, and
generates a setting screen for displaying a plurality of the workpiece images respectively corresponding to the plurality of exposure times, and
the setting device is configured to be capable of receiving selection of one exposure time from the plurality of exposure times via the setting screen, and then receiving adjustment of an image processing parameter to be executed for the plurality of light reception images acquired based on the selected exposure time.

2. An optical displacement measurement system comprising:
a light projecting/receiving module including a light projecting unit that irradiates a workpiece with slit light extending in an X direction and an image sensor that includes a plurality of pixels two-dimensionally arranged in a U direction corresponding to the X direction and a V direction orthogonal to the U direction, receives reflected light reflected from the workpiece by the plurality of pixels, and outputs a light reception image indicating a light receiving amount distribution;
a moving mechanism that relatively moves the light projecting/receiving module and the workpiece;
a setting device configured to set control conditions of the light projecting/receiving module and the moving mechanism; and
a control unit that controls the light projecting/receiving module and the moving mechanism based on the control conditions,
wherein the control conditions include a plurality of exposure times, different from each other, of the image sensor,
the control unit
controls the light projecting/receiving module to sequentially acquire a plurality of the light reception images of the workpiece based on each of the plurality of exposure times while causing the moving mechanism to relatively move the light projecting/receiving module and the workpiece within each of measurement ranges including at least a common range,
acquires XYZ coordinate information indicating a shape of the workpiece based on the plurality of light reception images for each of the plurality of exposure times to generate a workpiece image indicating the shape of the workpiece based on the XYZ coordinate information, and
generates a setting screen for displaying a plurality of the workpiece images respectively corresponding to the plurality of exposure times,
the control conditions include the measurement range, a drive control parameter including a movement speed of the moving mechanism, and a number of times of imaging of the image sensor within the measurement range, and
the setting device determines the drive control parameter based on the measurement range, the number of times of imaging of the image sensor within the measurement range, and each of the plurality of exposure times.

3. The optical displacement measurement system according to claim 1, wherein
the plurality of exposure times include a first exposure time and a second exposure time different from the first exposure time, and
the control unit
controls the image sensor to acquire a plurality of the light reception images of the workpiece based on the first exposure time while causing the moving mechanism to relatively move the light projecting/receiving module and the workpiece within one measurement range of the measurement ranges, and
performs controlling the image sensor to acquire a plurality of the light reception images of the workpiece based on the second exposure time while causing the moving mechanism to relatively move the light projecting/receiving module and the workpiece within another measurement range of the measurement ranges automatically after the acquisition of the plurality of the light reception images based on the first exposure time ends.

4. The optical displacement measurement system according to claim 3, wherein the control unit acquires the plurality of light reception images based on the second exposure time during the acquisition of the XYZ coordinate information based on the plurality of light reception images acquired in the first exposure time.

5. The optical displacement measurement system according to claim 1, wherein
the setting device further includes a storage unit that stores the XYZ coordinate information in each of the plurality of exposure times, and
when a switching instruction of a distance image indicating a height of the workpiece in a Z direction on an XY plane or a three-dimensional image indicating a three-dimensional shape of the workpiece as the workpiece image to be displayed on the setting screen is received via the setting screen, the control unit generates the setting screen in which switching to the distance image or the three-dimensional image has been performed according to the switching instruction based on the XYZ coordinate information stored in the storage unit.

6. The optical displacement measurement system according to claim 5, wherein
the setting screen in which a plurality of the workpiece images corresponding to at least two of the plurality of exposure times are displayed side by side is generated, and
when the switching instruction for any one of the plurality of workpiece images displayed side by side is received, the switching instruction is also applied to rest of the plurality of workpiece images displayed side by side.

7. The optical displacement measurement system according to claim 5, wherein
the plurality of exposure times include a first exposure time and a second exposure time different from the first exposure time, and
the control unit
generates the setting screen for displaying the workpiece image corresponding to the first exposure time, and
applies the switching instruction for the workpiece image corresponding to the first exposure time also to the workpiece image corresponding to the second exposure time to display the workpiece image corresponding to the second exposure time on the setting screen when an instruction for displaying the workpiece image corresponding to the second exposure time on the setting screen is received.

8. The optical displacement measurement system according to claim 1, wherein the control unit
generates the setting screen in which a plurality of the workpiece images corresponding to at least two of the plurality of exposure times are displayed side by side, and
displays, when an instruction for changing a display condition including enlargement, reduction, and an angle with respect to any one of the plurality of workpiece images displayed side by side is received, rest of the plurality of workpiece images displayed side by side on the setting screen based on the changed display condition.

9. The optical displacement measurement system according to claim 1, wherein
the plurality of exposure times include a first exposure time and a second exposure time different from the first exposure time, and
the control unit
generates the setting screen for displaying the workpiece image corresponding to the first exposure time, and
displays the workpiece image corresponding to the second exposure time on the setting screen while maintaining a display condition including enlargement, reduction, and an angle with respect to the workpiece image corresponding to the first exposure time when an instruction for displaying the workpiece image corresponding to the second exposure time on the setting screen is received.

10. The optical displacement measurement system according to claim 1, wherein the control unit
controls, when a change of at least one of the plurality of exposure times is received via the setting screen, the light projecting/receiving module to sequentially acquire the plurality of light reception image of the workpiece while causing the moving mechanism to relatively move the light projecting/receiving module and the workpiece within the measurement range based on the control conditions including the exposure time related to the change, and
acquires the XYZ coordinate information after the change based on the plurality of light reception images in the exposure time related to the change, generates the workpiece image after the change based on the XYZ coordinate information after the change, and updates the display of the setting screen.

11. The optical displacement measurement system according to claim 1, wherein
the control conditions include the measurement range, a drive control parameter including a movement speed of the moving mechanism, and a number of times of imaging of the image sensor within the measurement range, and
the setting device determines the drive control parameter based on the measurement range, the number of times of imaging of the image sensor within the measurement range, and each of the plurality of exposure times.

12. The optical displacement measurement system according to claim 11, wherein
the control conditions further include a unit measurement time for which one two-dimensional cross-sectional profile is measured based on the light reception image, and
the setting device
determines a scanning time required to scan the measurement range based on the unit measurement time and a number of times of imaging of the image sensor within the measurement range, and
determines the movement speed based on the measurement range and the scanning time.

13. The optical displacement measurement system according to claim 11, wherein
the drive control parameter further includes an acceleration and a deceleration of the moving mechanism, and
the setting device calculates an acceleration and an acceleration start position required to reach the movement speed at a point in time when the light projecting/receiving module starts measurement within the measurement range, and a deceleration and a stop position required for a stop after the light projecting/receiving module ends the measurement within the measurement range.

14. The optical displacement measurement system according to claim 1, wherein after selection of one exposure time from the plurality of exposure times is received, the setting device sequentially executes image processing on a plurality of the light reception images acquired based on the selected exposure time or peak candidate information acquired from the plurality of light reception images using each of a plurality of peak detection parameters, and displays a plurality of the workpiece images respectively corresponding to the plurality of peak detection parameters.

15. The optical displacement measurement system according to claim 1, wherein
the setting device further includes a storage unit that stores different default control conditions respectively corresponding to measured distances of the light projecting/receiving module, and
when an input of a measured distance of the light projecting/receiving module is received via the setting screen, the setting device reads a corresponding default control condition of the default control conditions from the storage unit.

16. The optical displacement measurement system according to claim 2, wherein
the plurality of exposure times include a first exposure time and a second exposure time different from the first exposure time, and
the control unit
controls the image sensor to acquire a plurality of the light reception images of the workpiece based on the first exposure time while causing the moving mechanism to relatively move the light projecting/receiving module and the workpiece within one measurement range of the measurement ranges, and
performs control to acquire a plurality of the light reception images of the workpiece based on the second exposure time while causing the moving mechanism to relatively move the light projecting/receiving module and the workpiece within another measurement range of the measurement ranges automatically after the acquisition of the plurality of the light reception images based on the first exposure time ends.

17. The optical displacement measurement system according to claim 1, wherein
the setting device further includes a storage unit that stores the XYZ coordinate information in each of the plurality of exposure times, and
when a switching instruction of a distance image indicating a height of the workpiece in a Z direction on an XY plane or a three-dimensional image indicating a three-dimensional shape of the workpiece as the workpiece image to be displayed on the setting screen is received via the setting screen, the control unit generates the setting screen in which switching to the distance image or the three-dimensional image has been performed according to the switching instruction based on the XYZ coordinate information stored in the storage unit.

18. The optical displacement measurement system according to claim 2, wherein the control unit
controls, when a change of at least one of the plurality of exposure times is received via the setting screen, the light projecting/receiving module to sequentially acquire the plurality of light reception image of the workpiece while causing the moving mechanism to relatively move the light projecting/receiving module and the workpiece within the measurement range based on the control conditions including the exposure time related to the change, and
acquires the XYZ coordinate information after the change based on the plurality of light reception images in the exposure time related to the change, generates the workpiece image after the change based on the XYZ coordinate information after the change, and updates the display of the setting screen.

19. The optical displacement measurement system according to claim 2, wherein after selection of one exposure time from the plurality of exposure times is received, the setting device sequentially executes image processing on a plurality of the light reception images acquired based on the selected exposure time or peak candidate information acquired from the plurality of light reception images using each of a plurality of peak detection parameters, and displays a plurality of the workpiece images respectively corresponding to the plurality of peak detection parameters.

20. The optical displacement measurement system according to claim 2, wherein
the setting device further includes a storage unit that stores different default control conditions respectively corresponding to measured distances of the light projecting/receiving module, and
when an input of a measured distance of the light projecting/receiving module is received via the setting screen, the setting device reads a corresponding default control condition of the default control conditions from the storage unit.
